(19) United States
(12) Patent Application Publication
(10) Pub. No.: US 2019/0194482 A1
(43) Pub. Date: Jun. 27, 2019

(54) WHITE PIGMENT COMPOSITION, DRIED OBJECT THEREOF, COATING METHOD, COATED MATTER, INK JET RECORDING METHOD, RECORDED MATTER, AND INK JET PRINTER

(71) Applicant: SEIKO EPSON CORPORATION, Tokyo (JP)

(72) Inventors: Soichi YAMAZAKI, Shiojiri-shi (JP); Kotaro IDEGAMI, Chino-shi (JP)

(73) Assignee: SEIKO EPSON CORPORATION, Tokyo (JP)

(21) Appl. No.: 16/229,061

(22) Filed: Dec. 21, 2018

(30) Foreign Application Priority Data
Dec. 26, 2017 (JP) 2017-249491
Dec. 26, 2017 (JP) 2017-249496
Dec. 26, 2017 (JP) 2017-249499

(51) Int. Cl. C09D 11/322; C09D 7/61; C09D 7/40; C01G 23/047; C01B 33/12

(52) U.S. Cl. CPC C09D 11/322; C09D 7/61; C09D 7/67; C01P 2004/62; C01G 23/047; C01B 33/12; C01P 2004/64; C09D 7/70

(57) ABSTRACT

An ink composition includes core shell titanium oxide particles that each have a core particle and a shell layer covering a surface of the core particle and formed of titanium oxide, and have an average particle diameter of 50 nm or more and 5000 nm or less, silicon oxide particles that have an average particle diameter of 3 nm or more and 100 nm or less, and a resin.

### BACKGROUND

### 1. Technical Field

The present invention relates to a white pigment composition, a dried object thereof, a coating method, coated matter, an ink jet recording method, recorded matter, and an ink jet printer.

### 2. Related Art

In an ink jet recording method, recording is performed by causing small droplets of an ink to fly and adhere to a recording medium. An ink jet recording ink (also referred to as “ink”) which is used in the recording method is obtained by dissolving or dispersing a coloring material (for example, a pigment) in a solvent, and various additives are added to the ink, as needed. Among such an ink, since a white ink is printed on a surface to be printed having low brightness such as a black surface to obtain recorded matter with good visibility, a white ink is also useful as a marking on industrial products of plastics or the like. As a pigment used for a white ink, an inorganic pigment of titanium oxide is generally used.

In such an inorganic pigment, the pigment may precipitate or agglomerate, mainly due to a difference in specific gravity between pigment particles and an ink solvent. As a result, there is a problem that an ink jet head is clogged or the ink lacks storage stability. On the other hand, when pigment particles each having a small particle diameter are used to suppress clogging, there is a problem that whiteness and covering power of the ink are not sufficient.

Titanium oxide is used as a white pigment contained in an ink, in various printing methods, from a viewpoint of low cost. However, since the titanium oxide has a large difference in specific gravity from a solvent, there is a problem that precipitation tends to occur. In particular, in a case of increasing a particle size and a content of the titanium oxide in order to obtain high covering power and whiteness, the precipitation further tends to occur. In addition, there is also a problem that the titanium oxide tends to be solidified according to progress of aggregation.

Various studies have been conducted against such problems. For example, JP-A-2006-274214 (Japanese Patent No. 4715275) discloses a white pigment for an aqueous ink, including a core particle and a titanium oxide layer which covers a surface of the core particle, in which when a material having a specific gravity smaller than a specific gravity of titanium oxide is used, even when increasing a particle size of the white pigment, it is possible to cope with both excellent stability to precipitation and excellent covering power.

JP-A-2013-60513 discloses a white ink jet ink including titanium oxide and a urethane resin, in which it is possible to improve re-dispersibility of a white ink by setting a ratio between an average particle diameter of the titanium oxide and an average particle diameter of the urethane resin within a predetermined range. In addition, JP-A-2013-60513 also discloses that it is possible to obtain an ink with excellent whiteness by setting the average particle diameter and a content of the titanium oxide within a predetermined range or by setting an acid value of the urethane resin within a predetermined range.

However, for the white pigment for an aqueous ink described in JP-A-2006-274214 (Japanese Patent No. 4715275), it is required to further improve stability to precipitation. In addition, for such a white pigment for an aqueous ink, it is also required to further improve whiteness.

In JP-A-2013-60513, the titanium oxide having a large average particle diameter of 300 nm or more is used in order to improve whiteness. In this case, precipitation of the titanium oxide cannot be avoided. Therefore, in JP-A-2013-60513, on the assumption that titanium oxide precipitates, the precipitated and agglomerated titanium oxide is re-dispersed by using a stirring mechanism or the like. Accordingly, in the white ink described in JP-A-2013-60513, it is not possible to prevent the titanium oxide from precipitating and the titanium oxide from existing stably in the ink.

In addition, further improvement of stability to precipitation and whiteness is not a task specific to a field of an aqueous ink as described above. For example, further improvement of stability to precipitation and whiteness is also required in a field of paint.

### SUMMARY

An advantage of some aspects of the invention is to provide a white pigment composition capable of improving stability to precipitation and whiteness with good balance, a dried object thereof, a coating method, coated matter, an ink jet recording method, recorded matter, and an ink jet printer.

The present inventors have intensively studied and have found that, in a white pigment composition obtained by combining core shell titanium oxide particles having a predetermined particle diameter, silicon oxide particles having a predetermined particle diameter, and a resin, stability to precipitation and whiteness can be improved in good balance.

That is, aspects of the invention are as follows.

(1) A white pigment composition including: core shell titanium oxide particles that each have a core particle and a shell layer covering a surface of the core particle and formed of titanium oxide, and have an average particle diameter of 50 nm or more and 5000 nm or less; silicon oxide particles that have an average particle diameter of 3 nm or more and 100 nm or less; and a resin.

(2) The white pigment composition according to (1), in which, when a coating medium is coated with the white pigment composition to form predetermined coated matter, Expression (1) is satisfied.

L₁*/L₂*≥1.10 (1)

L₁*: Brightness (L* value) after drying the coated matter at 160° C.

L₂*: Brightness (L* value) after drying the coated matter at a room temperature

(3) The white pigment composition according to (1) or (2), in which, when the white pigment composition is put into a container having a columnar internal shape and is centrifuged at a centrifugal force of 100 G for 10 hours, there is no sediment in which a ratio of a thickness to a height of the entire white pigment composition is 0.025 or more.

(4) The white pigment composition according to any one of (1) to (3), further including: a solvent, in which the solvent includes water and at least one selected from the group consisting of organic solvents having a boiling point of 190° C. or lower.

(5) The white pigment composition according to any one of (1) to (4), in which a content of moisture to the entire white pigment composition is 50% by mass or more.

(6) The white pigment composition according to any one of (1) to (5), in which a ratio Dₐ/D_{b} between an average particle diameter Dₐ of the silicon oxide particles and an average particle diameter D_{b} of the core shell titanium oxide particles is less than 1.

(7) The white pigment composition according to any one of (1) to (6), in which the average particle diameter of the silicon oxide particles is 3 nm or more and 50 nm or less.

(8) The white pigment composition according to any one of (1) to (7), in which a content of the core shell titanium oxide particles to the entire white pigment composition is 2% by mass or more and 15% by mass or less, a content of the silicon oxide particles to the entire white pigment composition is 2% by mass or more and 15% by mass or less, and a content of the resin to the entire white pigment composition is 2% by mass or more and 15% by mass or less.

(9) The white pigment composition according to any one of (1) to (8), in which an average particle diameter of particles included in the white pigment composition is 50 nm or more and 5000 nm or less.

(10) The white pigment composition according to any one of (1) to (9), in which the resin includes at least one selected from the group consisting of a urethane resin, a styrene-acrylic resin, polyacrylic acid, and a polyester resin.

(11) The white pigment composition according to any one of (1) to (10), in which an average particle diameter of the resin is 20 nm or more and 200 nm or less.

(12) The white pigment composition according to any one of (1) to (11), which is for a white paint.

(13) The white pigment composition according to any one of (1) to (11), which is for a white ink.

(14) A dried object of a white pigment composition, which has a dried form of the white pigment composition according to any one of (1) to (13).

(15) A coating method including: coating a coating medium with the white pigment composition according to any one of (1) to (13); and drying the white pigment composition with which the coating medium is coated.

(16) Coated matter including: a coating medium; and the dried object of a white pigment composition according to (14), with which the coating medium is coated.

(17) An ink jet recording method including: discharging the white pigment composition according to (13) to a recording medium by an ink jet method to coat the recording medium; and drying the white pigment composition with which the recording medium is coated.

(18) Recorded matter including: a recording medium; and the dried object of a white pigment composition according to (14), with which recording is performed on the recording medium.

(19) An ink jet printer which discharges an ink from an ink jet head, in which the ink is the white pigment composition according to (13).

(20) A white pigment composition including: titanium oxide particles having an average particle diameter of 15 nm or more and 100 nm or less; silicon oxide particles having an average particle diameter of 3 nm or more and 100 nm or less; and a resin, in which, when a coating medium is coated with the white pigment composition to form predetermined coated matter, Expression (2) is satisfied.

L₁*/L₂*≥1.10 (2)

L₁*: Brightness (L* value) after drying the coated matter at 160° C.

L₂*: Brightness (L* value) after drying the coated matter at a room temperature.

(21) The white pigment composition according to (20), further including: a solvent, in which the solvent includes water and at least one selected from the group consisting of organic solvents having a boiling point of 190° C. or lower.

(22) The white pigment composition according to (20) or (21), in which a content of moisture to the entire white pigment composition is 50% by mass or more.

(23) The white pigment composition according to (21) or (22), in which a pH of the white pigment composition is 5 or more and 11 or less, and the white pigment composition further includes polycarboxylic acid.

(24) The white pigment composition according to any one of (20) to (23), in which a ratio Dₐ/D_{b} between an average particle diameter Dₐ of the silicon oxide particles and an average particle diameter D_{b} of the titanium oxide particles is less than 1.

(25) The white pigment composition according to any one of (20) to (24), in which the average particle diameter of the silicon oxide particles is 3 nm or more and 50 nm or less.

(26) The white pigment composition according to any one of (20) to (25), in which a content of the titanium oxide particles to the entire white pigment composition is 2% by mass or more and 15% by mass or less, a content of the silicon oxide particles to the entire white pigment composition is 2% by mass or more and 15% by mass or less, and a content of the resin to the entire white pigment composition is 2% by mass or more and 15% by mass or less.

(27) The white pigment composition according to any one of (20) to (26), in which an average particle diameter of particles included in the white pigment composition is 20 nm or more and 150 nm or less.

(28) The white pigment composition according to any one of (20) to (27), in which the resin includes at least one selected from the group consisting of a urethane resin, a styrene-acrylic resin, polyacrylic acid, and a polyester resin.

(29) The white pigment composition according to any one of (20) to (28), in which an average particle diameter of the resin is 20 nm or more and 200 nm or less.

(30) The white pigment composition according to any one of (20) to (29), which is for a white paint.

(31) The white pigment composition according to any one of (20) to (29), which is for a white ink.

(32) A dried object of a white pigment composition, which has a dried form of the white pigment composition according to any one of (20) to (31).

(33) A coating method including: coating a coating medium with the white pigment composition according to any one of (20) to (31); and drying the white pigment composition with which the coating medium is coated.

(34) Coated matter including: a coating medium; and the dried object of a white pigment composition according to (32), with which the coating medium is coated.

(35) An ink jet recording method including: discharging the white pigment composition according to (31) to a recording medium by an ink jet method to coat the recording medium; and drying the white pigment composition with which the recording medium is coated.

(36) Recorded matter including: a recording medium; and the dried object of a white pigment composition according to (32), with which recording is performed on the recording medium.

(37) An ink jet printer which discharges an ink from an ink jet head, in which the ink is the white pigment composition according to (31).

(38) A white pigment composition including: titanium oxide particles having an average particle diameter of 15 nm or more and 100 nm or less; silicon oxide particles having an average particle diameter of 3 nm or more and 100 nm or less; and a resin, in which, when the white pigment composition is put into a container having a columnar internal shape and is centrifuged at a centrifugal force of 100 G for 10 hours, there is no sediment in which a ratio of a thickness to a height of the entire white pigment composition is 0.025 or more.

(39) The white pigment composition according to (38), further including: a solvent, in which the solvent includes water and at least one selected from the group consisting of organic solvents having a boiling point of 190° C. or lower.

(40) The white pigment composition according to (38) or (39), in which a content of moisture to the entire white pigment composition is 50% by mass or more.

(41) The white pigment composition according to (39) or (40), in which a pH of the white pigment composition is 5 or more and 11 or less, and the white pigment composition further includes polycarboxylic acid.

(42) The white pigment composition according to any one of (38) to (41), in which a ratio Dₐ/D_{b} between an average particle diameter Dₐ of the silicon oxide particles and an average particle diameter D_{b} of the titanium oxide particles is less than 1.

(43) The white pigment composition according to any one of (38) to (42), in which the average particle diameter of the silicon oxide particles is 3 nm or more and 50 nm or less.

(44) The white pigment composition according to any one of (38) to (43), in which a content of the titanium oxide particles to the entire white pigment composition is 2% by mass or more and 15% by mass or less, a content of the silicon oxide particles to the entire white pigment composition is 2% by mass or more and 15% by mass or less, and a content of the resin to the entire white pigment composition is 2% by mass or more and 15% by mass or less.

(45) The white pigment composition according to any one of (38) to (44), in which an average particle diameter of particles included in the white pigment composition is 20 nm or more and 150 nm or less.

(46) The white pigment composition according to any one of (38) to (45), in which the resin includes at least one selected from the group consisting of a urethane resin, a styrene-acrylic resin, polyacrylic acid, and a polyester resin.

(47) The white pigment composition according to any one of (38) to (46), in which an average particle diameter of the resin is 20 nm or more and 200 nm or less.

(48) The white pigment composition according to any one of (38) to (47), which is for a white paint.

(49) The white pigment composition according to any one of (38) to (47), which is for a white ink.

(50) A dried object of a white pigment composition, which has a dried form of the white pigment composition according to any one of (38) to (49).

(51) A coating method including: coating a coating medium with the white pigment composition according to any one of (38) to (49); and drying the white pigment composition with which the coating medium is coated.

(52) Coated matter including: a coating medium; and the dried object of a white pigment composition according to (50), with which the coating medium is coated.

(53) An ink jet recording method including: discharging the white pigment composition according to (49) to a recording medium by an ink jet method to coat the recording medium; and drying the white pigment composition with which the recording medium is coated.

(54) Recorded matter including: a recording medium; and the dried object of a white pigment composition according to (50), with which recording is performed on the recording medium.

(55) An ink jet printer which discharges an ink from an ink jet head, in which the ink is the white pigment composition according to (49).

### BRIEF DESCRIPTION OF THE DRAWINGS

The invention will be described with reference to the accompanying drawings, wherein like numbers reference like elements.

FIG. 1 is a flowchart showing an example of a coating method of an embodiment.

FIG. 2 is a flowchart showing an example of an ink jet recording method of an embodiment.

FIG. 3 is a schematic side view showing an example of an ink jet printer of an embodiment.

### DESCRIPTION OF EXEMPLARY EMBODIMENTS

Hereinafter, a first embodiment of the invention (hereinafter, referred to as “first embodiment”) will be described in detail, but the invention is not limited thereto, and various modifications can be made in a range not departing from the gist of the invention.

In the present specification, “stability to precipitation” refers to a property that precipitation of particles (particularly, core shell titanium oxide particles) included in a white pigment composition is suppressed and the particles exist stably. “Whiteness” refers to a property that when coating a coating medium (for example, a recording medium and matter to be painted) and drying the coated matter, brightness increases.

### White Pigment Composition

A white pigment composition of the first embodiment includes core shell titanium oxide particles having an average particle diameter of 50 nm or more and 5000 nm or less, silicon oxide particles having an average particle diameter of 3 nm or more and 100 nm or less, and a resin. Accordingly, for example, the stability to precipitation and the whiteness can be improved. Since the white pigment composition of the first embodiment can improve the stability to precipitation, for example, when used for a white ink or a white paint, storage stability is favorable, and when used for a white ink (for example, for a white ink of an ink jet method), dischargeability is favorable. In addition, since the white pigment composition of the first embodiment can improve the whiteness, even when used for both a white ink and a white paint, recorded matter and a coated article which have high whiteness can be obtained. Therefore, the white pigment composition of the first embodiment can be suitably used particularly for a white paint or a white ink (particularly, for a white ink used in an ink jet method).

Factors that such a white pigment composition can improve the stability to precipitation and the whiteness are considered as follows. However, the factors are not limited thereto. First, the inventors of the invention considered that as long as the whiteness can be improved when coating a coating medium (for example, a recording medium and matter to be painted) with a white pigment composition (for example, a white ink and a white paint) and drying the coated matter, it is not necessarily need to improve whiteness of the white pigment composition (for example, a white ink and a white paint). Based on this consideration, during the intensive study, a white pigment composition was obtained by combining core shell titanium oxide particles having an average particle diameter within a predetermined range, silicon oxide particles having an average particle diameter within a predetermined range, and a resin. In the coated matter obtained by coating the coating medium with the white pigment composition, when drying the coated matter, the constituent particles respectively agglomerate to form a nanocomposite, mainly due to the white pigment composition including the resin. Here, the silicon oxide particles, the titanium oxide particles, and the resin forming the white pigment composition have a high zeta potential (ζ potential) in this order in general, and when forming the nanocomposite, the components tend to agglomerate in order from a low zeta potential (ζ potential). That is, the resin, the core shell titanium oxide particles, and silicon oxide particles agglomerate in this order to form the nanocomposite. It is considered that light reflection increases to obtain an effect of improving the whiteness, mainly due to the formation of the nanocomposite. Further, it is considered that an electric double layer collapses, inter-particle spacing decreases, and the whiteness remarkably improves, mainly due to a fact that the silicon oxide particles finally agglomerate to form the nanocomposite. Meanwhile, it is considered that, mainly due to a fact that the white pigment composition includes silicon oxide particles having a small particle diameter in a predetermined range and high negative chargeability, charge repulsion occurs, particles (particularly, core shell titanium oxide particles) in the white pigment composition can exist stably by Brownian motion, and the stability to precipitation is improved.

The white pigment composition of the first embodiment can improve the whiteness of coated matter by drying the coated matter (for example, recorded matter and painted matter) obtained by coating a coating medium (for example, a recording medium and matter to be painted). The whiteness can be evaluated by measuring brightness (L*) in a CIE/L*a*b* color system, and high whiteness means that brightness (L*) is high.

The white pigment composition of the first embodiment preferably satisfies Equation (1), when a coating medium is coated with the white pigment composition to form predetermined coated matter. L₁*/L₂* is more preferably 1.15 or more, and still more preferably 1.20 or more. As a more detailed calculation method of L₁* and L₂*, a method described in Examples to be described later can be used.

L₁*/L₂*≥1.10 (1)

L₁*: Brightness (L* value) after drying the coated matter at 160° C.

L₂*: Brightness (L* value) after drying the coated matter at a room temperature

The white pigment composition of the first embodiment can improve the stability to precipitation of particles (particularly, core shell titanium oxide particles) in the white pigment composition. Therefore, in the white pigment composition, for example, when the white pigment composition is put into a container having a columnar internal shape and is centrifuged at a centrifugal force of 100 G for 10 hours, there is no sediment in which a ratio of a thickness to a height of the entire white pigment composition is 0.025 or more (preferably 0.023 or more and more preferably 0.021 or more).

An average particle diameter of particles included in the white pigment composition of the first embodiment is preferably 50 nm or more and 5000 nm or less, more preferably 75 nm or more and 3000 nm or less, and still more preferably 100 nm or more and 1000 nm or less, from a viewpoint of further improving the stability to precipitation and the whiteness during drying.

The white pigment composition of the first embodiment has, for example, a form in which particles are dispersed in an aqueous solvent. A pH of the white pigment composition is preferably 5.0 or more and 11.0 or less, more preferably 5.5 or more and 10.5 or less, and still more preferably 6.0 or more and 10.0 or less, from a viewpoint of further improving the stability to precipitation.

### Core Shell Titanium Oxide Particle

The white pigment composition of the first embodiment includes core shell titanium oxide particles. Each of the core shell titanium oxide particle has a core particle and a shell layer covering a surface of the core particle and formed of titanium oxide. However, the shell layer may contain a trace amount of components in addition to the titanium oxide, within a range not inhibiting actions and effects of the invention.

### Core Particle

It is preferable that a material of the core particle have a specific gravity smaller than a specific gravity of the titanium oxide forming the shell layer. Accordingly, the core shell titanium oxide particles have a smaller specific gravity, compared to pigment particles of the titanium oxide alone, having the same particle diameter. As a result, even when using the core shell titanium oxide particles having a relatively large particle diameter in order to enhance the whiteness and the covering power, the particles can exist stably in the composition. The whiteness and the covering power can be improved compared to the pigment particles of titanium oxide alone, depending on the material of the core particle but mainly due to a fact that light is refracted at an interface between the core particle and the shell layer.

The material of the core particle is not particularly limited. Examples thereof include a resin, and the resin may be an unmodified resin or may be a modified resin which has been modified with a modifier. The resin is preferably a water-soluble resin and more preferably a water-soluble resin having a polar group, from a viewpoint of more effectively and reliably exhibiting the actions and effects of the invention. Specific examples of such resin include one or more resins selected from the group consisting of a (meth)acrylic resin, a urethane resin, an epoxy resin, a polyimide resin, a polyamide resin, a polyvinyl alcohol resin, a cellulose resin, and a polyester resin. From a viewpoint of more effectively and reliably exhibiting the actions and effects of the invention, the polyester resin is preferable and a thermoplastic polyester resin is more preferable. In the present specification, “(meth)acrylic” means a concept including both acrylic and methacrylic.

The core particle preferably has a hollow structure, from a viewpoint of further reducing an apparent specific gravity of the core shell titanium oxide particle and further improving the stability to precipitation and dispersion stability. In addition, when having the hollow structure, for example, in a case where the material of the core particle is a resin, the covering power can be further improved, mainly due to a fact that light is refracted at an interface between the resin and a gap and at an interface between the resin and a titanium oxide layer (shell layer).

The core particle having the hollow structure can be prepared by a known method or by using a commercially available product. Examples of a method for preparing such a core particle include a method of heat-treating a thermoplastic polyester resin in a low ionic strength aqueous medium at a temperature equal to or higher than a glass transition temperature to hollow the resin, a method of adding a water-soluble organic compound to an aqueous dispersion of ionic group-containing polyester resin particles and removing the water-soluble organic compound by azeotropy to hollow the particles, and a method in which a solvent is added to an aqueous dispersion of ionic group-containing polyester resin particles, the particles are caused to swell, and then dried by a method such as spray drying to hollow the particles. More specific examples include a method described in paragraph 0018 of JP-A-2006-274214 (Japanese Patent No. 4715275).

Examples of the commercially available product include “ROPAQUE OP-84J”, “ROPAQUE OP-62”, and “ROPAQUE HP-91” (all are products of Rohm and Haas Co., Ltd.), “SX863A” and “SX866B” (both are products of JSR Corporation), “VONCOAT”, “GRANDOLL PP-1000”, and “GRANDOLL PP-1001” (all are products of DIC Corporation), and “Latex SBL 8801” (a product of Asahi Kasei Corporation). One kind of these commercially available products can be used alone and two or more kinds thereof can be used in combination.

### Shell Layer

A form of the titanium oxide forming the shell layer is not particularly limited, and examples thereof include an amorphous form, an anatase type crystalline form, and a rutile type crystalline form. From a viewpoint of further improving covering power, the anatase type crystalline form is preferable.

An average particle diameter of the core shell titanium oxide particles of the first embodiment is preferably 50 nm or more and 5000 nm or less. When the average particle diameter is 50 nm or more, the whiteness can be improved. When the average particle diameter is 5000 nm or less, the stability to precipitation can be improved. When the average particle diameter is within the above range, the whiteness and the stability to precipitation can be improved in good balance. From the same viewpoint, the average particle diameter is preferably 50 nm or more and 1000 nm or less, and more preferably 50 nm or more and 500 nm or less.

The average particle diameter of the core shell titanium oxide particles in the present specification refers to a “50% average particle diameter (d50) in terms of sphere obtained by a dynamic light scattering method”. As a method of measuring the average particle diameter, for example, the following method can be used for measuring. Particles in a dispersion medium are irradiated with light, and the diffracted scattered light generated is measured by detectors disposed in front of, side of, and behind the dispersion medium. Using the obtained measurement values, assuming that the particles that are originally amorphous are spherical, a cumulative curve is obtained regarding a total volume of a group of particles converted into spheres having a volume equal to the volume of the particles as 100%. At this time, a point at which a cumulative value is 50% is calculated.

The core shell titanium oxide particles of the first embodiment are not particularly limited, and may be prepared according to a known method (for example, a method of producing a white pigment for an aqueous ink described in JP-A-2006-274214 (Japanese Patent No. 4715275)). A commercially available product may be used therefor. Specific examples of a method of preparing the core shell titanium oxide particles include a method in which an aqueous emulsion including a core particle is added to an organic solvent in which titanium alkoxide has been dissolved, and the titanium alkoxide is hydrolyzed to causes titanium oxide to be precipitate on a surface of the core particle. More specific examples include a method described in JP-A-2006-274214 (Japanese Patent No. 4715275).

### Silicon Oxide Particle

The white pigment composition of the first embodiment includes silicon oxide particles. The silicon oxide particles of the first embodiment are not particularly limited, and examples thereof include fumed silica and colloidal silica. From a viewpoint of more effectively and reliably exhibiting the actions and effects of the invention, the colloidal silica is preferable. The term “colloidal silica” as used herein is a colloidal solution in which silica particles are dispersed in water, and refers to a concept including a modified colloidal silica which is modified due to modification of surfaces of silica particles by a modifying agent.

The colloidal silica may be prepared by a known method, and a commercially available product may also be used therefor. The commercially available product is not particularly limited, and examples thereof include SNOWTEX (trade name) ST-XS, SNOWTEX (trade name) ST-S, SNOWTEX (trade name) ST-30, SNOWTEX (trade name) ST-50, SNOWTEX (trade name) ST-30L, SNOWTEX (trade name) ST-XL, SNOWTEX (trade name) ST-YL, SNOWTEX (trade name) ST-ZL, SNOWTEX (trade name) MP-1040, SNOWTEX (trade name) MP-2040, SNOWTEX (trade name) MP-4540M, SNOWTEX (trade name) ST-UP, SNOWTEX (trade name) ST-PS-S, SNOWTEX (trade name) ST-PS-M, SNOWTEX (trade name) ST-OXS, SNOWTEX (trade name) ST-OS, SNOWTEX (trade name) ST-O, SNOWTEX (trade name) ST-O-40, SNOWTEX (trade name) ST-OL, SNOWTEX (trade name) ST-OYL, SNOWTEX (trade name) ST-OUP, SNOWTEX (trade name) ST-PS-SO, SNOWTEX (trade name) ST-PS-MO, SNOWTEX (trade name) ST-NXS, SNOWTEX (trade name) ST-NS, SNOWTEX (trade name) ST-N, SNOWTEX (trade name) ST-N-40, SNOWTEX (trade name) ST-CXS, SNOWTEX (trade name) ST-C, SNOWTEX (trade name) ST-CM, SNOWTEX (trade name) ST-AK-XS, SNOWTEX (trade name) ST-AK, SNOWTEX (trade name) ST-AK-L, SNOWTEX (trade name) ST-AK-YL, SNOWTEX (trade name) ST-AK-PS-S, SNOWTEX (trade name) ST-K2, SNOWTEX (trade name) LSS-35, SNOWTEX (trade name) LSS-45, SNOWTEX (trade name) PC-500, SNOWTEX (trade name) QAS-25, and SNOWTEX (trade name) QAS-40 (all are products of Nissan Chemical Corporation), and Klebosol 1498V-9, Klebosol 20H12, Klebosol 20H12E, Klebosol 30CAL25, Klebosol 30CAL50, Klebosol 30HB25K, Klebosol 30HB50K, Klebosol 30L12E, Klebosol 30N12, Klebosol 30R9, Klebosol 30R9BT, Klebosol 30R12C, Klebosol 30R25, Klebosol 30R50, Klebosol 30V9, Klebosol 30V12, Klebosol 30V25, Klebosol 30V50, Klebosol 40EA50, Klebosol 40R12, Klebosol 40R25, and Klebosol 50R50 (all are products of Clariant (Japan) K.K.). One kind of these commercially available products can be used alone and two or more kinds thereof can be used in combination.

An average particle diameter of the silicon oxide particles of the first embodiment is 3 nm or more and 100 nm or less. When the average particle diameter is 3 nm or more within the above range, the whiteness and the stability to precipitation can be improved. From a viewpoint of further improving the whiteness and the stability to precipitation, the average particle diameter is preferably 3 nm or more and 50 nm or less, and more preferably 3 nm or more and 30 nm or less.

A method of measuring the average particle diameter of the silicon oxide particles is not particularly limited. For example, the average particle diameter of the silicon oxide particles can be measured by a method of calculating the average particle diameter from a relationship between a specific surface area obtained by a Sears method or a BET method and a density, a dynamic light scattering method, and a centrifugal precipitation method.

A ratio Dₐ/D_{b} between an average particle diameter Dₐ of the silicon oxide particles and an average particle diameter D_{b} of the core shell titanium oxide particles is preferably less than 1. When the ratio Dₐ/D_{b} is less than 1, the whiteness tends to further be improved. From the same viewpoint, the ratio Dₐ/D_{b} is preferably 0.5 or less, and more preferably 0.4 or less.

### Resin

The white pigment composition of the first embodiment includes a resin. When including resin, the core shell titanium oxide particles and silicon oxide particles can be agglomerated to form a nanocomposite during drying, and adhesion to the coating medium is excellent.

The resin may be an unmodified resin and may be a modified resin which has been modified with a modifier. The resin is not particularly limited, and examples thereof include one or more resins selected from the group consisting of a (meth)acrylic resin, a urethane resin, an epoxy resin, a polyimide resin, a polyamide resin, a polyvinyl alcohol resin, a cellulose resin, and a polyester resin. From a viewpoint of more effectively and reliably exhibiting the actions and effects of the invention, one or more resins selected from the group consisting of the (meth)acrylic resin, the urethane resin, the polyvinyl alcohol resin, and the polyester resin are preferable.

The (meth)acrylic resin is not particularly limited, and examples thereof include a polymer obtained from one or more acrylic monomers selected from the group consisting of (meth)acrylic acid, (meth)acrylic acid ester, acrylonitrile, cyanoacrylate, and acrylamide. The (meth)acrylic resin may be a homopolymer of the acrylic monomers described above, and may be a copolymer of the acrylic monomer described above and another monomer copolymerizable with the acrylic monomer. The other monomer is not particularly limited, and examples thereof include one or more selected from the group consisting of styrene, olefin, vinyl acetate, vinyl chloride, vinyl alcohol, vinyl ether, vinyl pyrrolidone, vinyl pyridine, vinyl carbazole, vinyl imidazole, and vinylidene chloride. A type of bonding of the copolymer described above is not particularly limited, and examples thereof include random, block, alternating, and graft.

The urethane resin is not particularly limited, and examples thereof include a polymer obtained by reacting a polyisocyanate and a polyol by a known method. The polyisocyanate is not particularly limited, and examples thereof include linear, branched, or cyclic aliphatic isocyanate and aromatic isocyanate. One kind of these polyisocyanates can be used alone and two or more kinds thereof can be used in combination. The polyol is not particularly limited, and examples thereof include a polyether polyol (for example, polyethylene glycol, polypropylene glycol, and polytetramethylene glycol), and a polycarbonate polyol (for example, a reaction product of diols with dimethyl alkyl carbonate or cyclic carbonate). One kind of these polyols can be used alone and two or more kinds thereof can be used in combination.

The polyvinyl alcohol resin is not particularly limited, and examples thereof include a polymer obtained from vinyl acetate. The polyvinyl alcohol may be a homopolymer of vinyl acetate (polyvinyl alcohol) and may also be a copolymer of vinyl acetate and another monomer other than the acrylic monomer, copolymerizable with vinyl acetate. A type of bonding of the copolymer described above is not particularly limited, and examples thereof include random, block, alternating, and graft. One kind of these polyvinyl alcohols can be used alone and two or more kinds thereof can be used in combination.

The polyester resin is not particularly limited, and examples thereof include polybutylene terephthalate, polytrimethylene terephthalate, polyethylene terephthalate, polyethylene naphthalate, and copolymers thereof. One kind of these polyester resins can be used alone and two or more kinds thereof can be used in combination.

A form of these resins is not particularly limited, for example, may be a suspension form or an emulsion form.

Among these, from a viewpoint of further improving the stability to precipitation and the whiteness, at least one selected from the group consisting of a urethane resin, a styrene-acrylic resin (styrene-acrylic copolymer), polyacrylic acid, a polyvinyl alcohol, and a polyester resin is preferable. From a viewpoint of further improving water resistance of coated matter (for example, recorded matter), at least one selected from the group consisting of the urethane resin, the styrene-acrylic resin, the polyacrylic acid, and the polyester resin is more preferable.

The white pigment composition of the first embodiment preferably includes a resin having an average particle diameter of 20 nm or more and 200 nm or less, more preferably includes a resin having an average particle diameter of 30 nm or more and 180 nm or less, and still more preferably includes a resin having an average particle diameter of 50 nm or more and 150 nm or less, from a viewpoint of further improving the stability to precipitation and the whiteness. The average particle diameter of the resin refers to a “50% average particle diameter (d50) in terms of sphere obtained by a dynamic light scattering method”, and can be calculated by the same method as the calculation method described in the section of the average particle diameter of the core shell titanium oxide particles.

Each content of the core shell titanium oxide particles, silicon oxide particles, and the resin of the first embodiment is preferably 2% by mass or more and 15% by mass or less, more preferably 3% by mass or more and 12% by mass or less, and still more preferably 5% by mass or more and 10% by mass or less, with respect to the entire white pigment composition (100% by mass), from a viewpoint of further improving the stability to precipitation and the whiteness. Each content of the core shell titanium oxide particles, the silicon oxide particles, and the resin is a content when converted into a solid content, and the same is applied in the following. In addition, each content is indicated by an integer value rounded off to the decimal point.

In addition, each of a ratio of the content of the silicon oxide particles to the content of the core shell titanium oxide particles of the first embodiment, a ratio of the content of the resin to the content of the core shell titanium oxide particles, and a ratio of the content of the resin to the content of the silicon oxide particles is preferably 0.2 or more and 7.5 or less, more preferably 0.5 or more and 5.0 or less, and still more preferably 1.0 or more and 3.0 or less, from a viewpoint of further improving the stability to precipitation and the whiteness.

### Solvent

The white pigment composition of the first embodiment may further include a solvent. Examples of the solvent include water and an organic solvent.

The water is not particularly limited, and examples thereof include ion exchanged water, ultrafiltered water, reverse osmosis water, distilled water, and ultrapure water.

The organic solvent is not particularly limited, and examples thereof include alcohols or glycols such as glycerin, ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, 1,6-hexanediol, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol monobutyl ether, diethylene glycol mono-t-butyl ether, propylene glycol monomethyl ether, propylene glycol monoethyl ether, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, dipropylene glycol mono-iso-propyl ether, diethylene glycol dimethyl ether, diethylene glycol diethyl ether, diethylene glycol dibutyl ether, diethylene glycol ethyl methyl ether, diethylene glycol butyl methyl ether, triethylene glycol dimethyl ether, tetraethylene glycol dimethyl ether, dipropylene glycol dimethyl ether, dipropylene glycol diethyl ether, tripropylene glycol dimethyl ether, methanol, ethanol, n-propyl alcohol, iso-propyl alcohol, n-butanol, 2-butanol, tert-butanol, iso-butanol, n-pentanol, 2-pentanol, 3-pentanol, and tert-pentanol, N,N-dimethylformamide, N,N-dimethylacetamide, 2-pyrrolidone, N-methyl-2-pyrrolidone, 2-oxazolidone, 1,3-dimethyl-2-imidazolidinone, dimethyl sulfoxide, sulfolane, and 1,1,3,3-tetramethylurea. One kind of these solvents can be used alone and two or more kinds thereof can be used in combination.

Among these solvents, it is preferable that water and/or an organic solvent having a boiling point of 190° C. or lower (preferably having a boiling point of 185° C. or lower and more preferably having a boiling point of 180° C. or lower) (hereinafter also referred to as a “specific organic solvent”) be included, from a viewpoint of further improving the whiteness. Specific examples of the organic solvent having a boiling point of 190° C. or lower include ethylene glycol (boiling point: 197° C.; hereinafter numbers in parentheses indicate boiling points), triethylene glycol (125° C.), propylene glycol (188° C.), ethylene glycol mono-iso-propyl ether (144° C.), ethylene glycol mono-n-butyl ether (171° C.), propylene glycol monomethyl ether (121° C.), propylene glycol monoethyl ether (132° C.), propylene glycol mono-t-butyl ether (171° C.), propylene glycol mono-n-propyl ether (149° C.), propylene glycol mono-n-butyl ether (170° C.), diethylene glycol dimethyl ether (162° C.), diethylene glycol diethyl ether (188° C.), diethylene glycol ethyl methyl ether (179° C.), dipropylene glycol dimethyl ether (175° C.), methanol (65° C.), ethanol (78° C.), n-propyl alcohol (82° C.), iso-propyl alcohol (82° C.), n-butanol (117° C.), 2-butanol (99° C.), tert-butanol (82° C.), iso-butanol (108° C.), n-pentanol (138° C.), 2-pentanol (119° C.), 3-pentanol (114° C.), N,N-dimethylformamide (153° C.), N,N-dimethylacetamide (165° C.), dimethyl sulfoxide (189° C.), and 1,1,3,3-tetramethylurea (177° C.).

Among these organic solvents, it is preferable that the organic solvent be one or more selected from the group consisting of glycerin, ethylene glycol, diethylene glycol, triethylene glycol, 2-pyrrolidone, N-methyl-2-pyrrolidone, 1,3-propanediol, 1,4-butanediol, and 1,5-pentanediol, from a viewpoint of functioning as a moisturizing agent. Hereinafter, these organic solvents are also referred to as a moisturizing agent.

Among these organic solvents, it is preferable that the organic solvent be one or more selected from the group consisting of ethylene glycol monomethyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol monobutyl ether, diethylene glycol mono-t-butyl ether, propylene glycol monomethyl ether, propylene glycol monoethyl ether, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, dipropylene glycol mono-iso-propyl ether, diethylene glycol dimethyl ether, diethylene glycol diethyl ether, diethylene glycol dibutyl ether, diethylene glycol ethyl methyl ether, diethylene glycol butyl methyl ether, triethylene glycol dimethyl ether, tetraethylene glycol dimethyl ether, dipropylene glycol dimethyl ether, dipropylene glycol diethyl ether, tripropylene glycol dimethyl ether, 1,2-hexanediol, and 2-pyrrolidone, from a viewpoint of functioning as a penetrating agent. Hereinafter, these organic solvents are also referred to as a moisturizing agent.

A content of the solvent in the white pigment composition of the first embodiment is preferably 50% by mass or more (for example, 50% by mass or more and 85% by mass or less), more preferably 55% by mass or more, and still more preferably 60% by mass or more, with respect to the entire white pigment composition (100% by mass), from a viewpoint of more effectively and reliably exhibiting the actions and effects of the invention.

A content of the moisturizing agent in the white pigment composition of the first embodiment is preferably 1% by mass or more and 10% by mass or less with respect to the entire white pigment composition (100% by mass), from a viewpoint of more effectively and reliably exhibiting the actions and effects of the invention. A content of the penetrating agent is preferably 1% by mass or more and 3% by mass or less, from a viewpoint of more effectively and reliably exhibiting the actions and effects of the invention.

A content of the moisture with respect to the entire white pigment composition of the first embodiment is preferably 50% by mass or more (for example, 50% by mass or more and 75% by mass or less), more preferably 53% by mass or more, and still more preferably 55% by mass or more, with respect to the entire white pigment composition (100% by mass), from a viewpoint of further improving the whiteness. A total content of the water and the specific organic solvent in the white pigment composition of the first embodiment is preferably 45% by mass or more (for example, 45% by mass or more and 80% by mass or less), more preferably 50% by mass or more, and still more preferably 55% by mass or more, with respect to the entire white pigment composition (100% by mass), from a viewpoint of further improving the whiteness.

### Polycarboxylic Acid

The white pigment composition of the first embodiment preferably includes polycarboxylic acid, from a viewpoint of more stably dispersing the particles (particularly, titanium oxide particles) in the white pigment composition. The polycarboxylic acid may be low molecular weight polycarboxylic acid and may also be polymeric polycarboxylic acid. As the polycarboxylic acid, those commercially available as a dispersant can generally be used. Examples of the commercially available product include “CARRYBON L-400” and “SANSPARL PS-2” (both are products of Sanyo Chemical Industries, Ltd.) and “DEMOL EP” and “DEMOL P” (both are products of Kao Corporation). One kind of these polycarboxylic acids can be used alone and two or more kinds thereof can be used in combination.

A content of the polycarboxylic acid is preferably more than 0% by mass and 1% by mass or less, in terms of solid content, with respect to the entire white pigment composition (100% by mass), from a viewpoint of more effectively and reliably exhibiting the actions and effects of the invention.

In the white pigment composition of the first embodiment, it is preferable that a pH of the white pigment composition be 5 or more and 11 or less and the white pigment composition include the polycarboxylic acid, from a viewpoint of further improving the stability to precipitation.

### Surfactant

The white pigment composition of the first embodiment preferably includes a surfactant, from a viewpoint of further improving wettability of the white pigment composition with which a coating medium (for example, a recording medium) is coated. The surfactant is not particularly limited, and examples thereof include an acetylene glycol surfactant, a fluorine surfactant, and a silicone surfactant. One kind of these surfactants can be used alone and two or more kinds thereof can be used in combination. Among these, the acetylene glycol surfactant is preferable, from a viewpoint of further improving the wettability. The acetylene glycol surfactant is not particularly limited, and examples thereof include OLFINE (trade name) 104 series, OLFINE E series such as OLFINE E1010, SURFYNOL (trade name) 465, SURFYNOL (trade name) 61, and SURFYNOL (trade name) DF110D (all are products of Nissin Chemical Industry Co., Ltd.). One kind of these acetylene glycol surfactants can be used alone and two or more kinds thereof can be used in combination.

A content of the surfactant may be, for example, more than 0% by mass and 1% by mass or less, with respect to the entire white pigment composition (100% by mass).

In addition, the white pigment composition of the first embodiment may further include an additive other than the above components. Examples of the additive include a recording medium dissolving agent, a nozzle clogging preventing agent, a preservative, an antioxidant, a conductivity regulator, a pH adjuster, a viscosity modifier, a surface tension regulator, and an oxygen absorber. One kind of these additives may be used alone and two or more kinds thereof may be used in combination.

### Dried Object

A dried object of the first embodiment has a dried form of the white pigment composition of the first embodiment. The dried object of the first embodiment has a high whiteness. Therefore, when using the dried object of the first embodiment, coated matter (for example, recorded matter and painted matter) with excellent whiteness can be obtained.

### Coated Matter

Coated matter of the first embodiment includes a coating medium and the dried object of the first embodiment, with which the coating medium is coated. Since the coated matter of the first embodiment includes the dried object with high whiteness, the coated matter can be suitably used particularly as recorded matter and painted matter. In a case where the coated matter is recorded matter, the recorded matter includes a recording medium and the dried object of the first embodiment, with which recording is performed on the recording medium. In a case where the coated matter is painted matter, the painted matter includes matter to be painted and the dried object of the first embodiment, with which the matter to be painted is painted.

In a case of using the coated matter as the recorded matter, the recording medium is not particularly limited, and examples thereof include paper, cardboard, a textile product, a sheet or a film, plastic, glass, and ceramics. In a case of using the coated matter as the painted matter, the matter to be painted is not particularly limited, and examples thereof include a cement base material such as concrete and mortar, a metal base material such as steel material, glass, cloth, wood, a resin film, tile, and synthetic or natural leather. Examples of painted matter include a part for a vehicle, a household appliance, a building material, furniture, tableware, shoes, a bag, a leather accessory, clothing, and a hand stock for handicraft.

### Coating Method

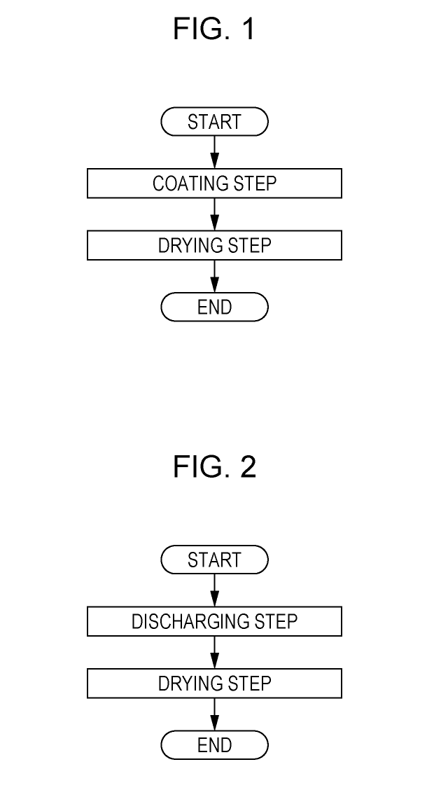

A coating method of the first embodiment includes a coating step of coating a coating medium with the white pigment composition of the first embodiment and a drying step of drying the white pigment composition with which the coating medium is coated. FIG. 1 is a flowchart showing an example of a coating method of the first embodiment. In the coating method of the first embodiment, since the white pigment composition of the first embodiment, which is excellent in stability to precipitation, is used, the coating medium can be uniformly coated with the white pigment composition. In addition, when drying the coating medium coated with the white pigment composition which is excellent in whiteness, white coated matter having high brightness can be formed.

### Coating Step

In the coating step of the first embodiment, the coating medium is coated with the white pigment composition of the first embodiment. In a case where the coating medium is the matter to be painted, the coating method (a painting method) is not particularly limited, and examples thereof include a brush coating method, a spray method, a dipping method, a flow coating method, and a spin coating method.

### Drying Step

In the drying step of the first embodiment, the coating medium coated with the white pigment composition of the first embodiment is dried. A heating temperature is not particularly limited, for example, is a room temperature (for example, 25° C.) to 250° C. From a viewpoint of further improving the whiteness, the heating temperature is preferably 50° C. to 220° C. and more preferably 100° C. to 200° C. Heating time is not particularly limited, and may be, for example, approximately 1 to 60 minutes.

### Ink Jet Recording Method

An ink jet recording method of the first embodiment includes a discharging step of discharging the white pigment composition of the first embodiment to a recording medium by an ink jet method to coat the recording medium and a drying step of drying the white pigment composition with which the recording medium is coated. FIG. 2 is a flowchart showing an example of the ink jet recording method of the first embodiment. In the ink jet recording method of the first embodiment, since the white pigment composition of the first embodiment, which is excellent in stability to precipitation, is used, dischargeability is excellent and the recording medium can be uniformly coated with the white pigment composition. In addition, when drying the recording medium coated with the white pigment composition of the first embodiment, white recorded matter having high brightness can be formed.

### Discharging Step

In the discharging step of the first embodiment, the white pigment composition of the first embodiment is discharged to a recording medium by an ink jet method to coat the recording medium. Examples of the recording medium include the recording medium exemplified in the section of “Coated Matter”. The ink jet method is not particularly limited, and examples thereof include a thermal jet ink jet, a piezo ink jet, a continuous ink jet, a roller application, and a spray application.

### Drying Step

In the drying step of the first embodiment, the recording medium coated with the white pigment composition of the first embodiment is dried. A heating temperature is not particularly limited, for example, is a room temperature (for example, 25° C.) to 250° C. From a viewpoint of further improving the whiteness, the heating temperature is preferably 50° C. to 220° C. and more preferably 100° C. to 200° C. Heating time is not particularly limited, and may be, for example, approximately 1 to 60 minutes.

### Ink Jet Printer (Ink Jet Recording Device)

An ink jet printer (also referred to as an “ink jet recording device”) of the first embodiment is an ink jet printer that discharges an ink from an ink jet head, and the ink is the white pigment composition of the first embodiment. In the ink jet printer of the first embodiment, since the white pigment composition of the first embodiment, which is excellent in stability to precipitation, is discharged as an ink from the ink jet head, dischargeability is excellent and when drying, white recorded matter having high brightness can be obtained.

The ink jet printer of the first embodiment preferably includes a drying device for drying a recording medium to which the ink is attached.

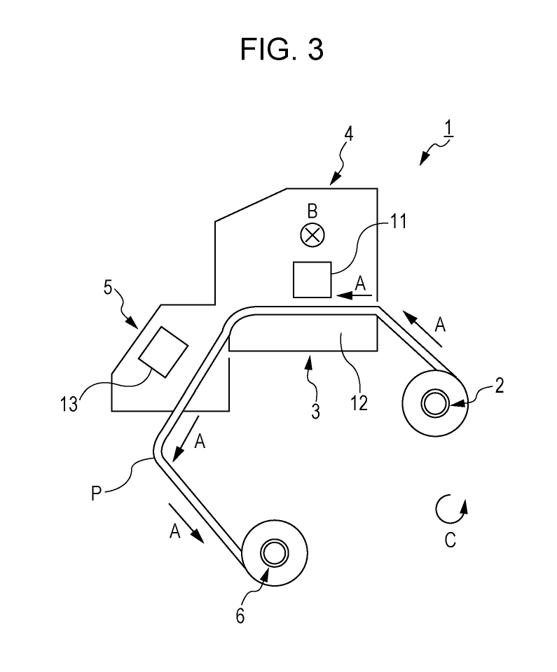

FIG. 3 is a schematic side view showing an example of the ink jet printer of the first embodiment. An ink jet printer 1 of the first embodiment includes a setting unit 2 for setting a roll-shaped recording medium P, a transport unit 3 that transports the recording medium P in a transport direction A, a recording unit 4 that is formed on an upstream side in the transport direction A and performs recording on the recording medium P with an ink, a dryer 5 that is formed on a downstream side of the transport direction A and dries the recording medium P on which recording has been performed with the ink, and a winding unit 6 that is formed on a further downstream side of the transport direction A and winds and recovers the dried recording medium P while rotating in a rotation direction C. The ink jet printer of the first embodiment is not particularly limited, as long as the printer can discharge the white pigment composition of the first embodiment as an ink, from the ink jet head. For example, it is not necessary to include the dryer 5 as a drying mechanism as the ink jet printer shown in FIG. 3.

### Setting Unit 2

The setting unit 2 is rotatable in the rotation direction C when transport unit 3 transports the recording medium P to the transport direction A.

### Transport Unit 3

The transport unit 3 includes a plurality of transporting rollers (not shown) and can transport the recording medium P to the transport direction A via the plurality of transporting rollers.

### Recording Unit 4

The recording unit 4 includes a recording head 11 and a platen 12 that faces the recording head 11 and supports a roll-shaped recording medium P. The recording head 11 includes an ink container (not shown) containing the white pigment composition (white pigment ink) of the first embodiment and a plurality of nozzles (not shown). When the recording medium P supported by the platen 12 faces the recording head 11, an ink is discharged from holes of the plurality of nozzles of the recording head 11 toward the recording medium P and recording is performed. Scanning is performed with the recording head 11 back and forth in a scanning direction B intersecting the transport direction A to perform recording.

### Dryer 5

The dryer 5 includes a heater 13 capable of heating by performing irradiation with electromagnetic waves (for example, infrared rays). The recording medium P on which recording has been performed with the ink can be dried.

### Winding Unit 6

The winding unit 6 is rotatable in the rotation direction C when winding the recording medium P.

Next, an example of a recording method using the ink jet printer 1 shown in FIG. 3 will be described. First, the roll-shaped recording medium P is set to the setting unit 2. Next, the recording medium P is transported toward the recording unit 4 toward the transport direction A by the transport unit 3. When the recording medium P is supported by the platen 12 and faces the recording head 11, the white pigment ink contained in the ink container of the recording head 11 is discharged from the holes of the plurality of nozzles toward the recording medium P and recording is performed. Scanning is performed with the recording head 11 back and forth in the scanning direction B intersecting the transport direction A to perform recording. Next, the recording medium P on which recording has been performed is transported toward the dryer by the transport unit 3, and the recording medium P on which recording has been performed with an ink is heated and dried by the heater 13 of the dryer 5. Next, the heated and dried recording medium P is wound by the winding unit 6, whereby the recording medium P can be recovered.

In the ink jet printer of the first embodiment, for example, an appropriate configuration may be added to the ink jet printer 1 shown in FIG. 3, and for example, a configuration of recording devices described in JP-A-2014-172285, JP-A-2015-150823, and JP-A-2016-107469 may be added thereto.

### EXAMPLES

Hereinafter, an embodiment of the invention will be described more specifically using Examples, but the first embodiment is not limited to these Examples.

### Preparation of Core Shell Titanium Oxide Particles

The core shell titanium oxide particles respectively having average particle diameters shown in Table 1 were prepared based on a method of producing a white pigment for an aqueous ink described in JP-A-2006-274214. That is, an aqueous emulsion including styrene-acrylic copolymer particles having a predetermined average particle diameter was mixed and stirred in a normal hexane solution in which titanium tetraisopropoxide was dissolved and centrifuged. Separated normal hexane and titanium oxide particles as a by-product were removed by the centrifugation to prepare an emulsion solution of core shell titanium oxide particles.

### Preparation of White Pigment Composition (White Pigment Ink)

Components shown in Table 1 were added to a container so as to have a composition shown in Table 1 (in Table 1, a number without a unit represents “part by mass”, and a numerical value of each content is a content with respect to the entire white pigment ink and rounded off to the decimal point.), mixed and stirred at a normal temperature, and filtered with a membrane filter having a pore size of 5 μm to obtain the white pigment compositions (white pigment inks) of Examples 1 to 14 and Comparative Examples 1 to 4.

With respect to the obtained white pigment compositions of Examples 1 to 14 and Comparative Examples 1 to 4, respective physical properties thereof were evaluated based on the following evaluation method.

### 1. Average Particle Diameter of Particles Included in White Pigment Ink

The average particle diameter (median diameter) of the particles included in the white pigment ink of each of Examples 1 to 14 was measured by the dynamic light scattering method. As a pretreatment, each white pigment ink was diluted with water and the obtained solution was used for measurement. As a measuring machine, a dynamic light scattering type particle diameter distribution measuring device “LB-550” (a product of HORIBA. Ltd.) was used. As a result of the measurement, the average particle diameter of the particles included in the white pigment ink of each of Examples 1 to 14 was approximately 100 to 1000 nm.

### 2. Ink Jet Dischargeability

An ink tank of “ink jet printer PX-M780” (a product of Seiko Epson Corporation) was filled with each white pigment composition, and an image of 100% duty was printed using plain paper of A4 size to evaluate ink jet dischargeability. The number of printed sheets was 10 and consecutive printings occurred therefor. Thereafter, a nozzle check was carried out to check the occurrence of nozzle omission.

In a case where the nozzle omission did not occur, it was determined as “favorable discharge”. In a case where the nozzle omission occurred, it was determined as “discharge failure”. Evaluation results are shown in Table 2.

### 3. Stability to Precipitation

Each white pigment ink was put into a sample container having a cylindrical internal shape to have a depth (height) of 24 mm and was centrifuged at a centrifugal force of 100 G for 10 hours. In this state, a depth (height) of a transparent supernatant part resulting from the precipitation of the white pigment was measured and the stability to precipitation of each white pigment composition was evaluated from the measurement value in accordance with the following evaluation criteria. Next, the sample container in which centrifugation was performed was tilted by 90 degrees to remove a liquid part of the white pigment ink. Thereafter, in the state where the sample container was tilted by 90 degrees to restore the container to the original state, the presence or absence of sediment (precipitate having lost flowability) at the bottom of the sample container was confirmed. In a case where the sediment was observed, a thickness of the sediment from the bottom was measured.

### Evaluation Criteria

A: The depth (height) of the supernatant part was 1 mm or less.

B: The depth (height) of the supernatant part was more than 1 mm and 5 mm or less.

C: The depth (height) of the supernatant part was more than 5 mm and less than 12 mm.

D: The depth (height) of the supernatant part was 12 mm or more.

### 4. Whiteness

An ink tank of an ink jet printer “PX-M870” (a product of Seiko Epson Corporation) was filled with each white pigment composition, and printing was performed on “Lumirror (R) S10-100 μm” (manufactured by Toray Industries. Inc., a commercially available PET sheet having no ink receiving layer) with a resolution of 1200×1200 dpi and a solid pattern of 100% duty to obtain two sheets of recorded matter. Next, one recorded matter was dried by heating at 160° C. for 5 minutes, and the other recorded matter was dried by standing for 1 day at a room temperature (23° C.). Next, with respect to the two types of the dried recorded matter, L* values in a CIE/L*a*b* color system were measured using a commercially available colorimeter with a black substrate (for example, “Gretag Macbeth Spetroscan and Spectrolino” which is a product of X-Rite, Incorporated.).

Based on each measurement value, a ratio of the L* value obtained after drying at 160° C. for 5 minutes to the L* value obtained after drying at a room temperature was calculated. Calculation results are shown in Table 2.

In addition, the whiteness of each white pigment composition was evaluated, using the L* value obtained after drying at 160° C. for 5 minutes, in accordance with the following evaluation criteria.

### Evaluation Criteria

A: The L* value was 75 or more.

B: The L* value was 70 or more and less than 75.

C: The L* value was 60 or more and less than 70.

D: The L* value was less than 60.

### 5. Water Resistance

The recorded matter dried at 160° C. for 5 minutes in “4. Whiteness” was allowed to penetrate into 40° C. of hot water for 1 hour. The presence or absence of a color change was visually confirmed and the water resistance was evaluated in accordance with the following evaluation criteria.

### Evaluation Criteria

A: No color change was seen.

B: A color change was seen.

TABLE 1
In Table 1, numerical values of the core shell titanium oxide, the silicon oxide, and the resin represent values of solid contents.

| | | | | | | | | | | | | | | | | | Compar- | Compar- | Compar- | Compar- |
|---|---|---|---|---|---|---|---|---|---|---|---|---|---|---|---|---|---|---|---|---|
| | | | | | | | | | | | | | | | | | ative | ative | ative | ative |
| | | | Example | Example | Example | Example | Example | Example | Example | Example | Example | Example | Example | Example | Example | Example | Example | Example | Example | Example |
| | | | 1 | 2 | 3 | 4 | 5 | 6 | 7 | 8 | 9 | 10 | 11 | 12 | 13 | 14 | 1 | 2 | 3 | 4 |
| White | Core shell | Average | — | — | — | — | — | — | — | — | — | — | — | — | — | — | — | 10 | — | — |
| pigment | titanium | particle | | | | | | | | | | | | | | | | | | |
| compo- | oxide | diameter: | | | | | | | | | | | | | | | | | | |
| sition | | 20 nm | | | | | | | | | | | | | | | | | | |
| | | Average | 10 | — | — | 15 | — | — | 2 | — | — | 10 | — | — | — | 10 | — | — | 10 | — |
| | | particle | | | | | | | | | | | | | | | | | | |
| | | diameter: | | | | | | | | | | | | | | | | | | |
| | | 50 nm | | | | | | | | | | | | | | | | | | |
| | | Average | — | 10 | — | — | 15 | — | — | 2 | — | — | 10 | — | — | — | — | — | — | 10 |
| | | particle | | | | | | | | | | | | | | | | | | |
| | | diameter: | | | | | | | | | | | | | | | | | | |
| | | 300 nm | | | | | | | | | | | | | | | | | | |
| | | Average | — | | 10 | — | — | 15 | — | — | 2 | — | — | 10 | 10 | — | — | — | — | — |
| | | particle | | | | | | | | | | | | | | | | | | |
| | | diameter: | | | | | | | | | | | | | | | | | | |
| | | 5000 nm | | | | | | | | | | | | | | | | | | |
| | | Average | — | — | — | — | — | — | — | — | — | — | — | — | — | — | 10 | — | — | — |
| | | particle | | | | | | | | | | | | | | | | | | |
| | | diameter: | | | | | | | | | | | | | | | | | | |
| | | 10000 nm | | | | | | | | | | | | | | | | | | |
| | Silicon | “ST- | 10 | — | — | — | — | 15 | — | — | — | — | 2 | — | 2 | — | — | — | — | — |
| | oxide | CXS” | | | | | | | | | | | | | | | | | | |
| | | (which is | | | | | | | | | | | | | | | | | | |
| | | a product | | | | | | | | | | | | | | | | | | |
| | | of Nissan | | | | | | | | | | | | | | | | | | |
| | | Chemical | | | | | | | | | | | | | | | | | | |
| | | Corpor- | | | | | | | | | | | | | | | | | | |
| | | ation) | | | | | | | | | | | | | | | | | | |
| | | Average | | | | | | | | | | | | | | | | | | |
| | | particle | | | | | | | | | | | | | | | | | | |
| | | diameter: | | | | | | | | | | | | | | | | | | |
| | | 3 nm | | | | | | | | | | | | | | | | | | |
| | | “ST-C” | — | 10 | — | — | — | — | 15 | — | — | — | — | 2 | — | 2 | — | — | — | — |
| | | (which is | | | | | | | | | | | | | | | | | | |
| | | a product | | | | | | | | | | | | | | | | | | |
| | | of Nissan | | | | | | | | | | | | | | | | | | |
| | | Chemical | | | | | | | | | | | | | | | | | | |
| | | Corpor- | | | | | | | | | | | | | | | | | | |
| | | ation) | | | | | | | | | | | | | | | | | | |
| | | Average | | | | | | | | | | | | | | | | | | |
| | | particle | | | | | | | | | | | | | | | | | | |
| | | diameter: | | | | | | | | | | | | | | | | | | |
| | | 10 nm | | | | | | | | | | | | | | | | | | |
| | | “ST-CM” | — | — | 10 | — | — | — | — | 15 | — | — | — | — | — | — | 2 | — | — | — |
| | | (which is | | | | | | | | | | | | | | | | | | |
| | | a product | | | | | | | | | | | | | | | | | | |
| | | of Nissan | | | | | | | | | | | | | | | | | | |
| | | Chemical | | | | | | | | | | | | | | | | | | |
| | | Corpor- | | | | | | | | | | | | | | | | | | |
| | | ation) | | | | | | | | | | | | | | | | | | |
| | | Average | | | | | | | | | | | | | | | | | | |
| | | particle | | | | | | | | | | | | | | | | | | |
| | | diameter: | | | | | | | | | | | | | | | | | | |
| | | 20 nm | | | | | | | | | | | | | | | | | | |
| | | “ST-YL” | — | — | — | 10 | — | — | — | — | 15 | — | — | — | — | — | — | — | — | — |
| | | (which is | | | | | | | | | | | | | | | | | | |
| | | a product | | | | | | | | | | | | | | | | | | |
| | | of Nissan | | | | | | | | | | | | | | | | | | |
| | | Chemical | | | | | | | | | | | | | | | | | | |
| | | Corpor- | | | | | | | | | | | | | | | | | | |
| | | ation) | | | | | | | | | | | | | | | | | | |
| | | Average | | | | | | | | | | | | | | | | | | |
| | | particle | | | | | | | | | | | | | | | | | | |
| | | diameter: | | | | | | | | | | | | | | | | | | |
| | | 60 nm | | | | | | | | | | | | | | | | | | |
| | | “MP- | — | — | — | — | 10 | — | — | — | — | 15 | — | — | — | — | — | 2 | — | — |
| | | 1040” | | | | | | | | | | | | | | | | | | |
| | | (which is | | | | | | | | | | | | | | | | | | |
| | | a product | | | | | | | | | | | | | | | | | | |
| | | of Nissan | | | | | | | | | | | | | | | | | | |
| | | Chemical | | | | | | | | | | | | | | | | | | |
| | | Corpor- | | | | | | | | | | | | | | | | | | |
| | | ation) | | | | | | | | | | | | | | | | | | |
| | | Average | | | | | | | | | | | | | | | | | | |
| | | particle | | | | | | | | | | | | | | | | | | |
| | | diameter: | | | | | | | | | | | | | | | | | | |
| | | 100 nm | | | | | | | | | | | | | | | | | | |
| | | “MP- | — | — | — | — | — | — | — | — | — | — | — | — | — | — | — | — | 10 | — |
| | | 2040” | | | | | | | | | | | | | | | | | | |
| | | (which is | | | | | | | | | | | | | | | | | | |
| | | a product | | | | | | | | | | | | | | | | | | |
| | | of Nissan | | | | | | | | | | | | | | | | | | |
| | | Chemical | | | | | | | | | | | | | | | | | | |
| | | Corpor- | | | | | | | | | | | | | | | | | | |
| | | ation) | | | | | | | | | | | | | | | | | | |
| | | Average | | | | | | | | | | | | | | | | | | |
| | | particle | | | | | | | | | | | | | | | | | | |
| | | diameter: | | | | | | | | | | | | | | | | | | |
| | | 200 nm | | | | | | | | | | | | | | | | | | |
| | | “MP- | — | — | — | — | — | — | — | — | — | — | — | — | — | — | — | — | — | 10 |
| | | 4540P” | | | | | | | | | | | | | | | | | | |
| | | (which is | | | | | | | | | | | | | | | | | | |
| | | a product | | | | | | | | | | | | | | | | | | |
| | | of Nissan | | | | | | | | | | | | | | | | | | |
| | | Chemical | | | | | | | | | | | | | | | | | | |
| | | Corpor- | | | | | | | | | | | | | | | | | | |
| | | ation) | | | | | | | | | | | | | | | | | | |
| | | Average | | | | | | | | | | | | | | | | | | |
| | | particle | | | | | | | | | | | | | | | | | | |
| | | diameter: | | | | | | | | | | | | | | | | | | |
| | | 450 nm | | | | | | | | | | | | | | | | | | |
| | Resin | Urethane | 10 | 10 | — | — | — | 15 | — | — | — | 2 | — | — | — | 10 | — | — | — | — |
| | | resin | | | | | | | | | | | | | | | | | | |
| | | (Average | | | | | | | | | | | | | | | | | | |
| | | particle | | | | | | | | | | | | | | | | | | |
| | | diameter: | | | | | | | | | | | | | | | | | | |
| | | 50 nm | | | | | | | | | | | | | | | | | | |
| | | Styrene- | — | — | 10 | — | — | — | 15 | — | — | — | 2 | — | — | — | — | 10 | — | — |
| | | acrylic | | | | | | | | | | | | | | | | | | |
| | | resin | | | | | | | | | | | | | | | | | | |
| | | (Average | | | | | | | | | | | | | | | | | | |
| | | particle | | | | | | | | | | | | | | | | | | |
| | | diameter: | | | | | | | | | | | | | | | | | | |
| | | 150 nm | | | | | | | | | | | | | | | | | | |
| | | Poly- | — | — | — | 10 | — | — | — | 15 | — | — | — | 2 | — | — | — | — | 10 | — |
| | | acrylic acid | | | | | | | | | | | | | | | | | | |
| | | (Average | | | | | | | | | | | | | | | | | | |
| | | particle | | | | | | | | | | | | | | | | | | |
| | | diameter: | | | | | | | | | | | | | | | | | | |
| | | 180 nm | | | | | | | | | | | | | | | | | | |
| | | Polyester | — | — | — | — | 10 | — | — | — | 15 | — | — | — | — | — | 2 | — | — | 10 |
| | | resin | | | | | | | | | | | | | | | | | | |
| | | (Average | | | | | | | | | | | | | | | | | | |
| | | particle | | | | | | | | | | | | | | | | | | |
| | | diameter: | | | | | | | | | | | | | | | | | | |
| | | 90 nm | | | | | | | | | | | | | | | | | | |
| | | Polyvinyl | — | — | — | — | — | — | — | — | — | — | — | — | 2 | — | — | — | — | — |
| | | alcohol | | | | | | | | | | | | | | | | | | |
| | | (Average | | | | | | | | | | | | | | | | | | |
| | | particle | | | | | | | | | | | | | | | | | | |
| | | diameter: | | | | | | | | | | | | | | | | | | |
| | | 300 nm | | | | | | | | | | | | | | | | | | |
| | Solvent | 1,2- | 2 | 2 | 2 | 2 | 2 | 2 | 2 | 2 | 2 | 2 | 2 | 2 | 2 | 2 | 2 | 2 | 2 | 2 |
| | | Hexane- | | | | | | | | | | | | | | | | | | |
| | | diol | | | | | | | | | | | | | | | | | | |
| | | Glycerin | 5 | 5 | 5 | 5 | 5 | 5 | 5 | 5 | 5 | 5 | 5 | 5 | 5 | 5 | 5 | 5 | 5 | 5 |
| | | 2- | 2 | 2 | 2 | 2 | 2 | 2 | 2 | 2 | 2 | 2 | 2 | 2 | 2 | 68 | 2 | 2 | 2 | 2 |
| | | Pyrro- | | | | | | | | | | | | | | | | | | |
| | | lidone | | | | | | | | | | | | | | | | | | |
| | | Propylene | 2 | 2 | 2 | 2 | 2 | 2 | 2 | 18 | 2 | 2 | 2 | 2 | 2 | 2 | 2 | 2 | 2 | 2 |
| | | glycol | | | | | | | | | | | | | | | | | | |
| | | Water | 58 | 58 | 58 | 53 | 53 | 43 | 40 | 40 | 56 | 61 | 74 | 74 | 74 | — | 74 | 66 | 58 | 58 |
| | | Ethanol | — | — | — | — | — | — | 16 | — | — | — | — | — | — | — | — | — | — | — |
| | Poly- | “CARRY- | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| | carbo- | BON L- | | | | | | | | | | | | | | | | | | |
| | xylic | 400” | | | | | | | | | | | | | | | | | | |
| | acid | (which is | | | | | | | | | | | | | | | | | | |
| | | a product | | | | | | | | | | | | | | | | | | |
| | | of Sanyo | | | | | | | | | | | | | | | | | | |
| | | Chemical | | | | | | | | | | | | | | | | | | |
| | | Industries, | | | | | | | | | | | | | | | | | | |
| | | Ltd.) | | | | | | | | | | | | | | | | | | |
| | Surfactant | OLFINE | 1 | 1 | 1 | 1 | 1 | 1 | 1 | 1 | 1 | 1 | 1 | 1 | 1 | 1 | 1 | 1 | 1 | 1 |
| | | (trade | | | | | | | | | | | | | | | | | | |
| | | name) | | | | | | | | | | | | | | | | | | |
| | | E1010 | | | | | | | | | | | | | | | | | | |

| | | | | | | | | | | | | | | | | | | |
|---|---|---|---|---|---|---|---|---|---|---|---|---|---|---|---|---|---|---|
| Content of core shell | 10 | 10 | 10 | 15 | 15 | 15 | 2 | 2 | 2 | 10 | 10 | 10 | 10 | 10 | 10 | 10 | 10 | 10 |
| titanium oxide (% by | | | | | | | | | | | | | | | | | | |
| mass) | | | | | | | | | | | | | | | | | | |
| Content of silicon | 10 | 10 | 10 | 10 | 10 | 15 | 15 | 15 | 15 | 15 | 2 | 2 | 2 | 2 | 2 | 2 | 10 | 10 |
| oxide (% by mass) | | | | | | | | | | | | | | | | | | |
| Content of resin (% | 10 | 10 | 10 | 10 | 10 | 15 | 15 | 15 | 15 | 2 | 2 | 2 | 2 | 10 | 2 | 10 | 10 | 10 |
| by mass) | | | | | | | | | | | | | | | | | | |
| Average particle | 0.06 | 0.03 | 0.004 | 1 | 0.33 | 0.0006 | 0.2 | 0.07 | 0.012 | 2 | 0.01 | 0.002 | 0.0006 | 0.2 | 0.002 | 5 | 4 | 1.5 |
| diameter of silicon | | | | | | | | | | | | | | | | | | |
| oxide/Average | | | | | | | | | | | | | | | | | | |
| particle diameter of | | | | | | | | | | | | | | | | | | |
| core shell titanium | | | | | | | | | | | | | | | | | | |
| oxide | | | | | | | | | | | | | | | | | | |

TABLE 2

| | | | Exam- | Exam- | Exam- | Exam- | Exam- | Exam- | Exam- | Exam- | Exam- | Exam- | Exam- |
|---|---|---|---|---|---|---|---|---|---|---|---|---|---|
| | | | ple 1 | ple 2 | ple 3 | ple 4 | ple 5 | ple 6 | ple 7 | ple 8 | ple 9 | ple 10 | ple 11 |
| Ink jet dischargeability | | | Fa- | Fa- | Fa- | Fa- | Fa- | Fa- | Fa- | Fa- | Fa- | Fa- | Fa- |
| | | | vor- | vor- | vor- | vor- | vor- | vor- | vor- | vor- | vor- | vor- | vor- |
| | | | able | able | able | able | able | able | able | able | able | able | able |
| | | | dis- | dis- | dis- | dis- | dis- | dis- | dis- | dis- | dis- | dis- | dis- |
| | | | charge | charge | charge | charge | charge | charge | charge | charge | charge | charge | charge |
| Eval- | Sta- | Bottom | 0.5 | 0.5 | 0.5 | 0.5 | 0.5 | 0.5 | 0.5 | 0.5 | 0.5 | 0.5 | 0.5 |
| u- | bil- | | mm | mm | mm | mm | mm | mm | mm | mm | mm | mm | mm |
| ation | ity to | | or | or | or | or | or | or | or | or | or | or | or |
| Re- | pre- | | less | less | less | less | less | less | less | less | less | less | less |
| sults | cip- | Super- | A | A | B | A | B | B | A | A | B | B | A |
| | ita- | natant | | | | | | | | | | | |
| | tion | part | | | | | | | | | | | |
| | White- | Ratio | 1.3 | 1.2 | 1.1 | 1.3 | 1.2 | 1.1 | 1.2 | 1.2 | 1.2 | 1.3 | 1.2 |
| | ness | (L* | | | | | | | | | | | |
| | | after | | | | | | | | | | | |
| | | drying | | | | | | | | | | | |
| | | at | | | | | | | | | | | |
| | | 160° C./ | | | | | | | | | | | |
| | | L* after | | | | | | | | | | | |
| | | drying | | | | | | | | | | | |
| | | at a | | | | | | | | | | | |
| | | room | | | | | | | | | | | |
| | | tem- | | | | | | | | | | | |
| | | per- | | | | | | | | | | | |
| | | ature) | | | | | | | | | | | |
| | | Eval- | B | A | A | B | A | A | B | B | B | B | A |
| | | u- | | | | | | | | | | | |
| | | ation | | | | | | | | | | | |

| Water resistance | A | A | A | A | A | A | A | A | A | A | A |
|---|---|---|---|---|---|---|---|---|---|---|---|
| | | | | | | | | Com- | Com- | Com- | Com- |
| | | | | | | | | par- | par- | par- | par- |
| | | | | | | | | ative | ative | ative | ative |
| | | | | | Exam- | Exam- | Exam- | Exam- | Exam- | Exam- | Exam- |
| | | | | | ple 12 | ple 13 | ple 14 | ple 1 | ple 2 | ple 3 | ple 4 |
| | | Ink jet dischargeability | | | Fa- | Fa- | Fa- | Discharge | Fa- | Fa- | Fa- |
| | | | | | vor- | vor- | vor- | failure | vor- | vor- | vor- |
| | | | | | able | able | able | | able | able | able |
| | | | | | dis- | dis- | dis- | | dis- | dis- | dis- |
| | | | | | charge | charge | charge | | charge | charge | charge |
| | | Eval- | Sta- | Bottom | 0.5 | 0.5 | 0.5 | 2 | 0.5 | 2 | 2 |
| | | u- | bil- | | mm | mm | mm | mm | mm | mm | mm |
| | | ation | ity to | | or | or | or | | or | | |
| | | Re- | pre- | | less | less | less | | less | | |
| | | sults | cip- | Super- | B | B | B | C | B | C | C |
| | | | ita- | natant | | | | | | | |
| | | | tion | part | | | | | | | |
| | | | White- | Ratio | 1.1 | 1.1 | 1.0 | 1.0 | 1.1 | 1.0 | 1.0 |
| | | | ness | (L* | | | | | | | |
| | | | | after | | | | | | | |
| | | | | drying | | | | | | | |
| | | | | at | | | | | | | |
| | | | | 160° C./ | | | | | | | |
| | | | | L* after | | | | | | | |
| | | | | drying | | | | | | | |
| | | | | at a | | | | | | | |
| | | | | room | | | | | | | |
| | | | | tem- | | | | | | | |
| | | | | per- | | | | | | | |
| | | | | ature) | | | | | | | |
| | | | | Eval- | A | A | B | A | D | B | B |
| | | | | u- | | | | | | | |
| | | | | ation | | | | | | | |

| | | | | | | | |
|---|---|---|---|---|---|---|---|
| Water resistance | A | B | A | A | A | A | A |

In the white pigment composition of each of Examples 1 to 14, which was obtained by combining the core shell titanium oxide particles having an average particle diameter in a predetermined range, the silicon oxide particles having an average particle diameter in a predetermined range, and the resin, the stability to precipitation (the supernatant part) was evaluated as A or B and also favorable result on the dischargeability was obtained. In addition, in each of these white pigment inks, the whiteness during drying was evaluated as A or B. From the above, it was confirmed that each of the white pigment inks can improve non-precipitating property and the whiteness in good balance. On the other hand, it was confirmed that when the average particle diameter of the core shell titanium oxide particles was too large as in Comparative Example 1, the non-precipitating property was not sufficient and the dischargeability was also poor and when the average particle diameter of the core shell titanium oxide particles was too small as in Comparative Example 2, the whiteness during drying was not sufficient. In addition, it was confirmed that when the average particle diameter of the silicon oxide particles was too large as in Comparative Examples 3 and 4, the non-precipitating property was not sufficient.

Hereinafter, a second embodiment of the invention (hereinafter, referred to as “second embodiment”) will be described in detail, but the invention is not limited thereto, and various modifications can be made in a range not departing from the gist of the invention.

In the present specification, “stability to precipitation” refers to a property that precipitation of particles (particularly titanium oxide particles) included in a white pigment composition is suppressed and the particles exist stably. “Whiteness” refers to a property that when coating a coating medium (for example, a recording medium and matter to be painted) and drying the coated matter, brightness increases.

### White Pigment Composition

A white pigment composition of the second embodiment includes titanium oxide particles having an average particle diameter of 15 nm or more and 100 nm or less, silicon oxide particles having an average particle diameter of 3 nm or more and 100 nm or less, and a resin, in which when a coating medium is coated with the white pigment composition to form coated matter, Expression (2) is satisfied. When the white pigment composition of the second embodiment has the configuration described above, both the stability to precipitation and the whiteness can be improved in good balance. Since the white pigment composition of the second embodiment can improve the stability to precipitation, for example, when used for a white ink or a white paint, storage stability is favorable, and when used for a white ink (for example, for a white ink of an ink jet method), dischargeability is favorable. In addition, since the white pigment composition of the second embodiment can improve the whiteness, even when used for both a white ink and a white paint, recorded matter and a coated article which have high whiteness can be obtained. Therefore, the white pigment composition of the second embodiment can be suitably used particularly for a white paint or a white ink (particularly, for a white ink used in an ink jet method).

Factors that such a white pigment composition can improve the stability to precipitation and the whiteness are considered as follows. However, the factors are not limited thereto. First, the inventors of the invention considered that as long as the whiteness can be improved when coating a coating medium (for example, a recording medium and matter to be painted) with a white pigment composition (for example, a white ink and a white paint) and heating and drying the coated matter, it is not necessarily need to improve whiteness of the white pigment composition (for example, a white ink and a white paint). Based on this consideration, during the intensive study, a white pigment composition was obtained by combining titanium oxide particles having an average particle diameter within a predetermined range, silicon oxide particles having an average particle diameter within a predetermined range, and a resin. In the coated matter obtained by coating the coating medium with the white pigment composition, when drying the coated matter, the constituent particles respectively agglomerate to form a nanocomposite, mainly due to the white pigment composition including the resin. Here, the silicon oxide particles, the titanium oxide particles, and the resin forming the white pigment composition have a high zeta potential (ζ potential) in this order in general, and when forming the nanocomposite, the components tend to agglomerate in order from a low zeta potential (ζ potential). That is, the resin, the titanium oxide particles, and silicon oxide particles agglomerate in this order to form the nanocomposite. It is considered that light reflection increases to obtain an effect of improving the whiteness, mainly due to the formation of the nanocomposite. Further, it is considered that an electric double layer collapses, inter-particle spacing decreases, and the whiteness remarkably improves, mainly due to a fact that the silicon oxide particles finally agglomerate to form the nanocomposite. Meanwhile, it is considered that, mainly due to a fact that the white pigment composition includes silicon oxide particles having a small particle diameter in a predetermined range and high negative chargeability, charge repulsion occurs, particles (particularly, titanium oxide particles) in the white pigment composition can exist stably by Brownian motion, and the stability to precipitation is improved.

The white pigment composition of the second embodiment can improve the whiteness of coated matter by drying the coated matter (for example, recorded matter and painted matter) obtained by coating a coating medium (for example, a recording medium and matter to be painted). The whiteness can be evaluated by measuring brightness (L*) in a CIE/L*a*b* color system, and high whiteness means that brightness (L*) is high.

The white pigment composition of the second embodiment satisfies Equation (2), when a coating medium is coated with the white pigment composition to form coated matter. L₁*/L₂* is more preferably 1.15 or more, and still more preferably 1.20 or more. As a more detailed calculation method of L₁* and L₂*, a method described in Examples to be described later can be used.

L₁*/L₂*≥1.10 (2)

L₁*: Brightness (L* value) after drying the coated matter at 160° C.

L₂*: Brightness (L* value) after drying the coated matter at a room temperature

An average particle diameter of particles included in the white pigment composition of the second embodiment is preferably 20 nm or more and 150 nm or less, more preferably 30 nm or more and 130 nm or less, and still more preferably 50 nm or more and 100 nm or less, from a viewpoint of further improving the stability to precipitation and the whiteness during heating and drying.

The white pigment composition of the second embodiment has, for example, a form in which particles are dispersed in an aqueous solvent. A pH of the white pigment composition is preferably 5.0 or more and 11.0 or less, more preferably 5.5 or more and 10.5 or less, and still more preferably 6.0 or more and 10.0 or less, from a viewpoint of further improving the stability to precipitation.

### Titanium Oxide Particle

The white pigment composition of the second embodiment includes titanium oxide particles. The titanium oxide particles may be, for example, modified titanium oxide particles of which surfaces are modified by a surface modifying agent and may also be unmodified titanium oxide particles.

A form of the titanium oxide particles is not particularly limited, and examples thereof include an amorphous form, an anatase type crystalline form, and a rutile type crystalline form. From a viewpoint of further improving covering power, the anatase type crystalline form is preferable.

As the titanium oxide particles, a commercially available product may be used. Examples of the commercially available product include “MT-01”, “MT-10EX”, “MT-05”, “MT-100S”, “MT-100TV”, “MT-100Z”, “MT-150EX”, “MT-150W”, “MT-100AQ”, “MT-100WP”, “MT-100SA”, “MT-100HD”, “MT-300HD”, “MT-500HD”, “MT-500B”, “MT-500SA”, “MT-600B”, “MT-600SA”, “MT-700B”, “MT-700HD”, “MTY-02”, “MTY-110M3S”, “MT-500SAS”, “MTY-700B S”, “JMT-1501B”, “JMT-150AO”, “JMT-150FI”, and “JMT-150ANO” (all are products of TAYCA Corporation), and “TTO-51(A)”, “TTO-51(C)”, “TTO-55(A)”, “TTO-55(B)”, “TTO-55(C)”, “TTO-55(D)”, “TTO-S-1”, “TTO-S-2”, “TTO-S-3”, “TTO-S-4”, “MPT-136”, “MPT-141”, “TTO-V-3”, “TTO-V-4”, “TTO-F-2”, “TTO-F-6”, and “TTO-W-5” (all are products of ISHIHARA SANGYO KAISHA, LTD.). One kind of these commercially available products can be used alone and two or more kinds thereof can be used in combination.

An average particle diameter of the titanium oxide particles of the second embodiment is 15 nm or more and 100 nm or less. When the average particle diameter is 15 nm or more, the whiteness can be improved. When the average particle diameter is 100 nm or less, the stability to precipitation can be improved. When the average particle diameter is within the above range, both the stability to precipitation and the whiteness can be improved in good balance. From the same viewpoint, the average particle diameter is preferably 30 nm or more and 100 nm or less, and more preferably 50 nm or more and 100 nm or less.

The average particle diameter of the titanium oxide particles in the present specification refers to a “50% average particle diameter (d50) in terms of sphere obtained by a dynamic light scattering method”. As a method of measuring the average particle diameter, for example, the following method can be used for measuring. Particles in a dispersion medium are irradiated with light, and the diffracted scattered light generated is measured by detectors disposed in front of, side of, and behind the dispersion medium. Using the obtained measurement values, assuming that the particles that are originally amorphous are spherical, a cumulative curve is obtained regarding a total volume of a group of particles converted into spheres having a volume equal to the volume of the particles as 100%. At this time, a point at which a cumulative value is 50% is calculated.

### Silicon Oxide Particle

The white pigment composition of the second embodiment includes silicon oxide particles. The silicon oxide particles of the second embodiment are not particularly limited, and examples thereof include fumed silica and colloidal silica. From a viewpoint of more effectively and reliably exhibiting the actions and effects of the invention, the colloidal silica is preferable. The term “colloidal silica” as used herein is a colloidal solution in which silica particles are dispersed in water, and refers to a concept including a modified colloidal silica which is modified due to modification of surfaces of silica particles by a modifying agent.

The colloidal silica may be prepared by a known method, and a commercially available product may also be used therefor. The commercially available product is not particularly limited, and examples thereof include SNOWTEX (trade name) ST-XS, SNOWTEX (trade name) ST-S, SNOWTEX (trade name) ST-30, SNOWTEX (trade name) ST-50, SNOWTEX (trade name) ST-30L, SNOWTEX (trade name) ST-XL, SNOWTEX (trade name) ST-YL, SNOWTEX (trade name) ST-ZL, SNOWTEX (trade name) MP-1040, SNOWTEX (trade name) MP-2040, SNOWTEX (trade name) MP-4540M, SNOWTEX (trade name) ST-UP, SNOWTEX (trade name) ST-PS-S, SNOWTEX (trade name) ST-PS-M, SNOWTEX (trade name) ST-OXS, SNOWTEX (trade name) ST-OS, SNOWTEX (trade name) ST-O, SNOWTEX (trade name) ST-O-40, SNOWTEX (trade name) ST-OL, SNOWTEX (trade name) ST-OYL, SNOWTEX (trade name) ST-OUP, SNOWTEX (trade name) ST-PS-SO, SNOWTEX (trade name) ST-PS-MO, SNOWTEX (trade name) ST-NXS, SNOWTEX (trade name) ST-NS, SNOWTEX (trade name) ST-N, SNOWTEX (trade name) ST-N-40, SNOWTEX (trade name) ST-CXS, SNOWTEX (trade name) ST-C, SNOWTEX (trade name) ST-CM, SNOWTEX (trade name) ST-AK-XS, SNOWTEX (trade name) ST-AK, SNOWTEX (trade name) ST-AK-L, SNOWTEX (trade name) ST-AK-YL, SNOWTEX (trade name) ST-AK-PS-S, SNOWTEX (trade name) ST-K2, SNOWTEX (trade name) LSS-35, SNOWTEX (trade name) LSS-45, SNOWTEX (trade name) PC-500, SNOWTEX (trade name) QAS-25, and SNOWTEX (trade name) QAS-40 (all are products of Nissan Chemical Corporation), and Klebosol 1498V-9, Klebosol 20H12, Klebosol 20H12E, Klebosol 30CAL25, Klebosol 30CAL50, Klebosol 30HB25K, Klebosol 30HB50K, Klebosol 30L12E, Klebosol 30N12, Klebosol 30R9, Klebosol 30R9BT, Klebosol 30R12C, Klebosol 30R25, Klebosol 30R50, Klebosol 30V9, Klebosol 30V12, Klebosol 30V25, Klebosol 30V50, Klebosol 40EA50, Klebosol 40R12, Klebosol 40R25, and Klebosol 50R50 (all are products of Clariant (Japan) K.K.). One kind of these commercially available products can be used alone and two or more kinds thereof can be used in combination.

An average particle diameter of the silicon oxide particles of the second embodiment is 3 nm or more and 100 nm or less. When the average particle diameter is within the above range, the whiteness and the stability to precipitation can be improved. From a viewpoint of further improving the whiteness and the stability to precipitation, the average particle diameter is preferably 3 nm or more and 50 nm or less, and more preferably 3 nm or more and 30 nm or less.

A method of measuring the average particle diameter of the silicon oxide particles is not particularly limited. For example, the average particle diameter of the silicon oxide particles can be measured by a method of calculating the average particle diameter from a relationship between a specific surface area obtained by a Sears method or a BET method and a density, a dynamic light scattering method, and a centrifugal precipitation method.

A ratio Dₐ/D_{b} between an average particle diameter Dₐ of the silicon oxide particles and an average particle diameter D_{b} of the titanium oxide particles is preferably less than 1. When the ratio Dₐ/D_{b} is less than 1, the whiteness tends to further be improved. From the same viewpoint, the ratio Dₐ/D_{b} is preferably 0.5 or less, and more preferably 0.4 or less.

### Resin

The white pigment composition of the second embodiment includes a resin. When including resin, the titanium oxide particles and silicon oxide particles can be agglomerated to form a nanocomposite during drying, and adhesion to the coating medium is excellent.

The resin may be an unmodified resin and may be a modified resin which has been modified with a modifier. The resin is not particularly limited, and examples thereof include one or more resins selected from the group consisting of a (meth)acrylic resin, a urethane resin, an epoxy resin, a polyimide resin, a polyamide resin, a polyvinyl alcohol resin, a cellulose resin, and a polyester resin. From a viewpoint of more effectively and reliably exhibiting the actions and effects of the invention, one or more resins selected from the group consisting of the (meth)acrylic resin, the urethane resin, the polyvinyl alcohol resin, and the polyester resin are preferable.

The (meth)acrylic resin is not particularly limited, and examples thereof include a polymer obtained from one or more acrylic monomers selected from the group consisting of (meth)acrylic acid, (meth)acrylic acid ester, acrylonitrile, cyanoacrylate, and acrylamide. The (meth)acrylic resin may be a homopolymer of the acrylic monomers described above, and may be a copolymer of the acrylic monomer described above and another monomer copolymerizable with the acrylic monomer. The other monomer is not particularly limited, and examples thereof include one or more selected from the group consisting of styrene, olefin, vinyl acetate, vinyl chloride, vinyl alcohol, vinyl ether, vinyl pyrrolidone, vinyl pyridine, vinyl carbazole, vinyl imidazole, and vinylidene chloride. A type of bonding of the copolymer described above is not particularly limited, and examples thereof include random, block, alternating, and graft.

The urethane resin is not particularly limited, and examples thereof include a polymer obtained by reacting a polyisocyanate and a polyol by a known method. The polyisocyanate is not particularly limited, and examples thereof include linear, branched, or cyclic aliphatic isocyanate and aromatic isocyanate. One kind of these polyisocyanates can be used alone and two or more kinds thereof can be used in combination. The polyol is not particularly limited, and examples thereof include a polyether polyol (for example, polyethylene glycol, polypropylene glycol, and polytetramethylene glycol), and a polycarbonate polyol (for example, a reaction product of diols with dimethyl alkyl carbonate or cyclic carbonate). One kind of these polyols can be used alone and two or more kinds thereof can be used in combination.

The polyvinyl alcohol resin is not particularly limited, and examples thereof include a polymer obtained from vinyl acetate. The polyvinyl alcohol may be a homopolymer of vinyl acetate (polyvinyl alcohol) and may also be a copolymer of vinyl acetate and another monomer other than the acrylic monomer, copolymerizable with vinyl acetate. A type of bonding of the copolymer described above is not particularly limited, and examples thereof include random, block, alternating, and graft. One kind of these polyvinyl alcohols can be used alone and two or more kinds thereof can be used in combination.

The polyester resin is not particularly limited, and examples thereof include polybutylene terephthalate, polytrimethylene terephthalate, polyethylene terephthalate, polyethylene naphthalate, and copolymers thereof. One kind of these polyester resins can be used alone and two or more kinds thereof can be used in combination.

A form of these resins is not particularly limited, for example, may be a suspension form or an emulsion form.

Among these, from a viewpoint of further improving the stability to precipitation and the whiteness, at least one selected from the group consisting of a urethane resin, a styrene-acrylic resin (styrene-acrylic copolymer), polyacrylic acid, a polyvinyl alcohol, and a polyester resin is preferable. From a viewpoint of further improving water resistance of coated matter (for example, recorded matter), at least one selected from the group consisting of the urethane resin, the styrene-acrylic resin, the polyacrylic acid, and the polyester resin is more preferable.

An average particle diameter of the resin is preferably 20 nm or more and 200 nm or less, more preferably 30 nm or more and 180 nm or less, and still more preferably 50 nm or more and 150 nm or less, from a viewpoint of further improving the stability to precipitation and the whiteness. The average particle diameter of the resin refers to a “50% average particle diameter (d50) in terms of sphere obtained by a dynamic light scattering method”, and can be calculated by the same method as the calculation method described in the section of the average particle diameter of the titanium oxide particles.

Each content of the titanium oxide particles, the silicon oxide particles, and the resin of the second embodiment is preferably 2% by mass or more and 15% by mass or less, more preferably 3% by mass or more and 12% by mass or less, and still more preferably 5% by mass or more and 10% by mass or less, with respect to the entire white pigment composition (100% by mass), from a viewpoint of further improving the stability to precipitation and the whiteness. Each content of the titanium oxide particles, the silicon oxide particles, and the resin is a content when converted into a solid content, and the same is applied in the following. In addition, each content is indicated by an integer value rounded off to the decimal point.

In addition, each of a ratio of the content of the silicon oxide particles to the content of the titanium oxide particles of the second embodiment, a ratio of the content of the resin to the content of the titanium oxide particles, and a ratio of the content of the resin to the content of the silicon oxide particles is preferably 0.2 or more and 7.5 or less, more preferably 0.5 or more and 5.0 or less, and still more preferably 1.0 or more and 3.0 or less, from a viewpoint of further improving the stability to precipitation and the whiteness.

### Solvent

The white pigment composition of the second embodiment may further include a solvent. Examples of the solvent include water and an organic solvent.

The water is not particularly limited, and examples thereof include ion exchanged water, ultrafiltered water, reverse osmosis water, distilled water, and ultrapure water.

The organic solvent is not particularly limited, and examples thereof include alcohols or glycols such as glycerin, ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, 1,6-hexanediol, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol monobutyl ether, diethylene glycol mono-t-butyl ether, propylene glycol monomethyl ether, propylene glycol monoethyl ether, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, dipropylene glycol mono-iso-propyl ether, diethylene glycol dimethyl ether, diethylene glycol diethyl ether, diethylene glycol dibutyl ether, diethylene glycol ethyl methyl ether, diethylene glycol butyl methyl ether, triethylene glycol dimethyl ether, tetraethylene glycol dimethyl ether, dipropylene glycol dimethyl ether, dipropylene glycol diethyl ether, tripropylene glycol dimethyl ether, methanol, ethanol, n-propyl alcohol, iso-propyl alcohol, n-butanol, 2-butanol, tert-butanol, iso-butanol, n-pentanol, 2-pentanol, 3-pentanol, and tert-pentanol, N,N-dimethylformamide, N,N-dimethylacetamide, 2-pyrrolidone, N-methyl-2-pyrrolidone, 2-oxazolidone, 1,3-dimethyl-2-imidazolidinone, dimethyl sulfoxide, sulfolane, and 1,1,3,3-tetramethylurea. One kind of these solvents can be used alone and two or more kinds thereof can be used in combination.

Among these solvents, it is preferable that water and at least one selected from the group consisting of organic solvents having a boiling point of 190° C. or lower (preferably having a boiling point of 185° C. or lower and more preferably having a boiling point of 180° C. or lower) (hereinafter also referred to as a “specific organic solvent”) be included, from a viewpoint of further improving the whiteness. Specific examples of the organic solvents having a boiling point of 190° C. or lower include ethylene glycol (boiling point: 197° C.; hereinafter numbers in parentheses indicate boiling points), triethylene glycol (125° C.), propylene glycol (188° C.), ethylene glycol mono-iso-propyl ether (144° C.), ethylene glycol mono-n-butyl ether (171° C.), propylene glycol monomethyl ether (121° C.), propylene glycol monoethyl ether (132° C.), propylene glycol mono-t-butyl ether (171° C.), propylene glycol mono-n-propyl ether (149° C.), propylene glycol mono-n-butyl ether (170° C.), diethylene glycol dimethyl ether (162° C.), diethylene glycol diethyl ether (188° C.), diethylene glycol ethyl methyl ether (179° C.), dipropylene glycol dimethyl ether (175° C.), methanol (65° C.), ethanol (78° C.), n-propyl alcohol (82° C.), iso-propyl alcohol (82° C.), n-butanol (117° C.), 2-butanol (99° C.), tert-butanol (82° C.), iso-butanol (108° C.), n-pentanol (138° C.), 2-pentanol (119° C.), 3-pentanol (114° C.), N,N-dimethylformamide (153° C.), N,N-dimethylacetamide (165° C.), dimethyl sulfoxide (189° C.), and 1,1,3,3-tetramethylurea (177° C.).

Among these organic solvents, it is preferable that the organic solvent be one or more selected from the group consisting of glycerin, ethylene glycol, diethylene glycol, triethylene glycol, 2-pyrrolidone, N-methyl-2-pyrrolidone, 1,3-propanediol, 1,4-butanediol, and 1,5-pentanediol, from a viewpoint of functioning as a moisturizing agent. Hereinafter, these organic solvents are also referred to as a moisturizing agent.

Among these organic solvents, it is preferable that the organic solvent be one or more selected from the group consisting of ethylene glycol monomethyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol monobutyl ether, diethylene glycol mono-t-butyl ether, propylene glycol monomethyl ether, propylene glycol monoethyl ether, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, dipropylene glycol mono-iso-propyl ether, diethylene glycol dimethyl ether, diethylene glycol diethyl ether, diethylene glycol dibutyl ether, diethylene glycol ethyl methyl ether, diethylene glycol butyl methyl ether, triethylene glycol dimethyl ether, tetraethylene glycol dimethyl ether, dipropylene glycol dimethyl ether, dipropylene glycol diethyl ether, tripropylene glycol dimethyl ether, 1,2-hexanediol, and 2-pyrrolidone, from a viewpoint of functioning as a penetrating agent. Hereinafter, these organic solvents are also referred to as a penetrating agent.

A content of the solvent in the white pigment composition of the second embodiment is preferably 50% by mass or more (for example, 50% by mass or more and 85% by mass or less), more preferably 55% by mass or more, and still more preferably 60% by mass or more, with respect to the entire white pigment composition (100% by mass), from a viewpoint of more effectively and reliably exhibiting the actions and effects of the invention.

A content of the moisturizing agent in the white pigment composition of the second embodiment is preferably 1% by mass or more and 10% by mass or less with respect to the entire white pigment composition (100% by mass), from a viewpoint of more effectively and reliably exhibiting the actions and effects of the invention. A content of the penetrating agent is preferably 1% by mass or more and 3% by mass or less, from a viewpoint of more effectively and reliably exhibiting the actions and effects of the invention.

A content of the moisture in the white pigment composition of the second embodiment is preferably 50% by mass or more (for example, 50% by mass or more and 75% by mass or less), more preferably 53% by mass or more, and still more preferably 55% by mass or more, with respect to the entire white pigment composition (100% by mass), from a viewpoint of further improving the whiteness. A total content of the water and the specific organic solvent in the white pigment composition of the second embodiment is preferably 45% by mass or more (for example, 45% by mass or more and 80% by mass or less), more preferably 50% by mass or more, and still more preferably 55% by mass or more, with respect to the entire white pigment composition (100% by mass), from a viewpoint of further improving the whiteness.

### Polycarboxylic Acid

The white pigment composition of the second embodiment preferably includes polycarboxylic acid, from a viewpoint of more stably dispersing the particles (particularly, titanium oxide particles) in the white pigment composition. The polycarboxylic acid may be low molecular weight polycarboxylic acid and may also be polymeric polycarboxylic acid. As the polycarboxylic acid, those commercially available as a dispersant can generally be used. Examples of the commercially available product include “CARRYBON L-400” and “SANSPARL PS-2” (both are products of Sanyo Chemical Industries, Ltd.) and “DEMOL EP” and “DEMOL P” (both are products of Kao Corporation). One kind of these polycarboxylic acids can be used alone and two or more kinds thereof can be used in combination.

A content of the polycarboxylic acid is preferably more than 0% by mass and 1% by mass or less, in terms of solid content, with respect to the entire white pigment composition (100% by mass), from a viewpoint of more effectively and reliably exhibiting the actions and effects of the invention.

In the white pigment composition of the second embodiment, it is preferable that a pH of the white pigment composition be 5 or more and 11 or less and the white pigment composition include the polycarboxylic acid, from a viewpoint of further improving the stability to precipitation.

### Surfactant

The white pigment composition of the second embodiment preferably includes a surfactant, from a viewpoint of further improving wettability of the white pigment composition with which a coating medium (for example, a recording medium) is coated. The surfactant is not particularly limited, and examples thereof include an acetylene glycol surfactant, a fluorine surfactant, and a silicone surfactant. One kind of these surfactants can be used alone and two or more kinds thereof can be used in combination. Among these, the acetylene glycol surfactant is preferable, from a viewpoint of further improving the wettability. The acetylene glycol surfactant is not particularly limited, and examples thereof include OLFINE (trade name) 104 series, OLFINE E series such as OLFINE E1010, SURFYNOL (trade name) 465, SURFYNOL (trade name) 61, and SURFYNOL (trade name) DF110D (all are products of Nissin Chemical Industry Co., Ltd.). One kind of these acetylene glycol surfactants can be used alone and two or more kinds thereof can be used in combination.

A content of the surfactant may be, for example, more than 0% by mass and 1% by mass or less, with respect to the entire white pigment composition (100% by mass).

In addition, the white pigment composition of the second embodiment may further include an additive other than the above components. Examples of the additive include a recording medium dissolving agent, a nozzle clogging preventing agent, a preservative, an antioxidant, a conductivity regulator, a pH adjuster, a viscosity modifier, a surface tension regulator, and an oxygen absorber. One kind of these additives may be used alone and two or more kinds thereof may be used in combination.

### Dried Object

A dried object of the second embodiment has a dried form of the white pigment composition of the second embodiment. The dried object of the second embodiment has a high whiteness. Therefore, when using the dried object of the second embodiment, coated matter (for example, recorded matter and painted matter) with excellent whiteness can be obtained.

### Coated Matter

Coated matter of the second embodiment includes a coating medium and the dried object of the second embodiment, with which the coating medium is coated. Since the coated matter of the second embodiment includes the dried object with high whiteness, the coated matter can be suitably used particularly as recorded matter and painted matter. In a case where the coated matter is recorded matter, the recorded matter includes a recording medium and the dried object of the second embodiment, with which recording is performed on the recording medium. In a case where the coated matter is painted matter, the painted matter includes matter to be painted and the dried object of the second embodiment, with which the matter to be painted is painted.

In a case of using the coated matter as the recorded matter, the recording medium is not particularly limited, and examples thereof include paper, cardboard, a textile product, a sheet or a film, plastic, glass, and ceramics. In a case of using the coated matter as the painted matter, the matter to be painted is not particularly limited, and examples thereof include a cement base material such as concrete and mortar, a metal base material such as steel material, glass, cloth, wood, a resin film, tile, and synthetic or natural leather. Examples of painted matter include a part for a vehicle, a household appliance, a building material, furniture, tableware, shoes, a bag, a leather accessory, clothing, and a hand stock for handicraft.

### Coating Method

A coating method of the second embodiment includes a coating step of coating a coating medium with the white pigment composition of the second embodiment and a drying step of drying the coating medium coated with the white pigment composition. FIG. 1 is a flowchart showing an example of the coating method of the second embodiment. In the coating method of the second embodiment, since the white pigment composition of the second embodiment, which is excellent in stability to precipitation, is used, the coating medium can be uniformly coated with the white pigment composition. In addition, when drying the coating medium coated with the white pigment composition which is excellent in whiteness, white coated matter having high brightness can be formed.

### Coating Step

In the coating step of the second embodiment, the coating medium is coated with the white pigment composition of the second embodiment. In a case where the coating medium is the matter to be painted, the coating method (a painting method) is not particularly limited, and examples thereof include a brush coating method, a spray method, a dipping method, a flow coating method, and a spin coating method.

### Drying Step

In a heating and drying step of the second embodiment, the coating medium coated with the white pigment composition of the second embodiment is heated and dried. A heating temperature is not particularly limited, for example, is a room temperature (for example, 25° C.) to 250° C. From a viewpoint of further improving the whiteness, the heating temperature is preferably 50° C. to 220° C. and more preferably 100° C. to 200° C. Heating time is not particularly limited, and may be, for example, approximately 1 to 60 minutes.

### Ink Jet Recording Method

An ink jet recording method of the second embodiment includes a discharging step of discharging the white pigment composition of the second embodiment to a recording medium by an ink jet method to coat the recording medium and a drying step of drying the recording medium coated with the white pigment composition. FIG. 2 is a flowchart showing an example of the ink jet recording method of the second embodiment. In the ink jet recording method of the second embodiment, since the white pigment composition of the second embodiment, which is excellent in stability to precipitation, is used, dischargeability is excellent and the recording medium can be uniformly coated with the white pigment composition. In addition, when drying the recording medium coated with the white pigment composition of the second embodiment, white recorded matter having high brightness can be formed.

### Discharging Step

In the discharging step of the second embodiment, the white pigment composition of the second embodiment is discharged to a recording medium by an ink jet method to coat the recording medium. Examples of the recording medium include the recording medium exemplified in the section of “Coated Matter”. The ink jet method is not particularly limited, and examples thereof include a thermal jet ink jet, a piezo ink jet, a continuous ink jet, a roller application, and a spray application.

### Drying Step

In a heating and drying step of the second embodiment, the recording medium coated with the white pigment composition of the second embodiment is heated and dried. A heating temperature is not particularly limited, for example, is a room temperature (for example, 25° C.) to 250° C. From a viewpoint of further improving the whiteness, the heating temperature is preferably 50° C. to 220° C. and more preferably 100° C. to 200° C. Heating time is not particularly limited, and may be, for example, approximately 1 to 60 minutes.

### Ink Jet Printer (Ink Jet Recording Device)

An ink jet printer (also referred to as an “ink jet recording device”) of the second embodiment is an ink jet printer that discharges an ink from an ink jet head, and the ink is the white pigment composition of the second embodiment. In the ink jet printer of the second embodiment, since the white pigment composition of the second embodiment, which is excellent in stability to precipitation, is discharged as an ink from the ink jet head, dischargeability is excellent and when drying, white recorded matter having high brightness can be obtained.

The ink jet printer of the second embodiment preferably includes a drying device for drying a recording medium to which the ink is attached.

FIG. 3 is a schematic side view showing an example of the ink jet printer of the second embodiment. An ink jet printer 1 of the second embodiment includes a setting unit 2 for setting a roll-shaped recording medium P, a transport unit 3 that transports the recording medium P in a transport direction A, a recording unit 4 that is formed on an upstream side in the transport direction A and performs recording on the recording medium P with an ink, a dryer 5 that is formed on a downstream side of the transport direction A and dries the recording medium P on which recording has been performed with the ink, and a winding unit 6 that is formed on a further downstream side of the transport direction A and winds and recovers the dried recording medium P while rotating in a rotation direction C.

### Setting Unit 2

The setting unit 2 is rotatable in the rotation direction C when transport unit 3 transports the recording medium P to the transport direction A.

### Transport Unit 3

The transport unit 3 includes a plurality of transporting rollers (not shown) and can transport the recording medium P to the transport direction A via the plurality of transporting rollers.

### Recording Unit 4

The recording unit 4 includes a recording head 11 and a platen 12 that faces the recording head 11 and supports a roll-shaped recording medium P. The recording head 11 includes an ink container (not shown) containing the white pigment composition (white pigment ink) of the second embodiment and a plurality of nozzles (not shown). When the recording medium P supported by the platen 12 faces the recording head 11, an ink is discharged from holes of the plurality of nozzles of the recording head 11 toward the recording medium P and recording is performed. Scanning is performed with the recording head 11 back and forth in a scanning direction B intersecting the transport direction A to perform recording.

### Dryer 5

The dryer 5 includes a heater 13 capable of heating by performing irradiation with electromagnetic waves (for example, infrared rays). The recording medium P on which recording has been performed with the ink can be dried.

### Winding Unit 6

The winding unit 6 is rotatable in the rotation direction C when winding the recording medium P.

Next, an example of a recording method using the ink jet printer 1 shown in FIG. 3 will be described. First, the roll-shaped recording medium P is set to the setting unit 2. Next, the recording medium P is transported toward the recording unit 4 toward the transport direction A by the transport unit 3. When the recording medium P is supported by the platen 12 and faces the recording head 11, the white pigment ink contained in the ink container of the recording head 11 is discharged from the holes of the plurality of nozzles toward the recording medium P and recording is performed. Scanning is performed with the recording head 11 back and forth in the scanning direction B intersecting the transport direction A to perform recording. Next, the recording medium P on which recording has been performed is transported toward the dryer by the transport unit 3, and the recording medium P on which recording has been performed with an ink is heated and dried by the heater 13 of the dryer 5. Next, the heated and dried recording medium P is wound by the winding unit 6, whereby the recording medium P can be recovered.

In the ink jet printer of the second embodiment, for example, an appropriate configuration may be added to the ink jet printer 1 shown in FIG. 3, and for example, a configuration of recording devices described in JP-A-2014-172285, JP-A-2015-150823, and JP-A-2016-107469 may be added thereto.

### EXAMPLES

Hereinafter, an embodiment of the invention will be described more specifically using Examples, but the second embodiment is not limited to these Examples.

### Preparation of White Pigment Composition (White Pigment Ink)

Components shown in Table 3 were added to a container so as to have a composition shown in Table 3 (in Table 3, a number without a unit represents “part by mass”, and a numerical value of each content is a content with respect to the entire white pigment ink and rounded off to the decimal point.), mixed and stirred at a normal temperature, and filtered with a membrane filter having a pore size of 5 μm to obtain the white pigment compositions (white pigment inks) of Examples 21 to 33 and Comparative Examples 21 to 26.

With respect to the obtained white pigment compositions of Examples 21 to 33 and Comparative Examples 21 to 26, respective physical properties thereof were evaluated based on the following evaluation method.

1. Average Particle Diameter of Particles included in White Pigment Ink

The average particle diameter (median diameter) of the particles included in the white pigment ink of each of Examples 21 to 33 was measured by a dynamic light scattering method. As a pretreatment, each white pigment ink was diluted with water and the obtained solution was used for measurement. As a measuring machine, a dynamic light scattering type particle diameter distribution measuring device “LB-550” (a product of HORIBA. Ltd.) was used. As a result of the measurement, the average particle diameter of the particles included in the white pigment ink of each of Examples 21 to 33 was approximately 20 to 150 nm.

### 2. Stability to Precipitation

Each white pigment ink was put into a rectangular parallelepiped sample container to seal the sample container and was centrifuged at a centrifugal force of 100 G for 10 hours. Next, the sample container in which centrifugation was performed was tilted by 90 degrees. In this state, a depth (height) of each white pigment was 24 mm. In this state, the presence or absence of a transparent supernatant part was confirmed. In a case where there was the supernatant part, a depth (height) of the supernatant part was measured, and the stability to precipitation of each white pigment composition was evaluated from the measurement value in accordance with the following evaluation criteria. A large depth of the supernatant part shows that a precipitate remarkably occurs.

### Evaluation Criteria

A: The depth (height) of the supernatant part was 1 mm or less.

B: The depth (height) of the supernatant part was more than 1 mm and 5 mm or less.

C: The depth (height) of the supernatant part was more than 5 mm and less than 12 mm.

D: The depth (height) of the supernatant part was 12 mm or more.

### 3. Whiteness

An ink tank of an ink jet printer (“PX-M870” which is a product of Seiko Epson Corporation) was filled with each white pigment composition, and printing was performed on “Lumirror (R) S10-100 μm” (manufactured by Toray Industries. Inc., a commercially available PET sheet having no ink receiving layer) with a resolution of 1200×1200 dpi and a solid pattern of 100% duty to obtain two sheets of recorded matter. Next, one recorded matter was dried by heating at 160° C. for 5 minutes, and the other recorded matter was dried by standing for 1 day at a room temperature (23° C.). Next, with respect to the two types of the dried recorded matter, L* values in a CIE/L*a*b* color system were measured using a commercially available colorimeter with a black substrate (“Gretag Macbeth Spetroscan and Spectrolino” which is a product of X-Rite, Incorporated.).

Based on each measurement value, a ratio of the L* value obtained after drying at 160° C. for 5 minutes to the L* value obtained after drying at a room temperature was calculated. Calculation results are shown in Table 4.

In addition, the whiteness of each white pigment composition was evaluated, using the L* value obtained after drying at 160° C. for 5 minutes, in accordance with the following evaluation criteria.

### Evaluation Criteria

A: The L* value was 75 or more.

B: The L* value was 70 or more and less than 75.

C: The L* value was 60 or more and less than 70.

D: The L* value was less than 60.

### 4. Water Resistance

The recorded matter dried at 160° C. for 5 minutes in “3. Whiteness” was allowed to penetrate into 40° C. of hot water for 1 hour. The presence or absence of a color change was visually confirmed and the water resistance was evaluated in accordance with the following evaluation criteria.

### Evaluation Criteria

A: No color change was seen.

B: A color change was seen.

TABLE 3
In Table 3, numerical values of the titanium oxide, the silicon oxide, and the resin represent values of solid contents.

| | | | | | | | | | | | | | | | | | | Com- | Com- | Com- | Com- |
|---|---|---|---|---|---|---|---|---|---|---|---|---|---|---|---|---|---|---|---|---|---|
| | | | | | | | | | | | | | | | | | | par- | par- | par- | par- |
| | | | | | | | | | | | | | | | | Comparative | Comparative | ative | ative | ative | ative |
| | | | Exam | Exam | Exam | Exam | Exam | Exam | Exam | Exam | Exam | Exam | Exam | Exam | Exam | Example | Example | Example | Example | Example | Example |
| | | | 21 | 22 | 23 | 24 | 25 | 26 | 27 | 28 | 29 | 30 | 31 | 32 | 33 | 21 | 22 | 23 | 24 | 25 | 26 |
| White | Titanium oxide | “MT05” | — | — | — | — | — | — | — | — | — | — | — | — | — | — | — | 10 | — | — | — |
| pigment- | | (which is | | | | | | | | | | | | | | | | | | | |
| composition | | a product | | | | | | | | | | | | | | | | | | | |
| | | of TAYCA | | | | | | | | | | | | | | | | | | | |
| | | Cor- | | | | | | | | | | | | | | | | | | | |
| | | poration) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 10 nm | | | | | | | | | | | | | | | | | | | |
| | | “MT100WP” | 10 | — | — | 15 | — | — | 2 | — | — | 10 | — | — | — | — | — | — | 10 | — | 10 |
| | | (which is a | | | | | | | | | | | | | | | | | | | |
| | | product of | | | | | | | | | | | | | | | | | | | |
| | | TAYCA | | | | | | | | | | | | | | | | | | | |
| | | Cor- | | | | | | | | | | | | | | | | | | | |
| | | poration) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 15 nm | | | | | | | | | | | | | | | | | | | |
| | | “MT600B” | — | 10 | — | — | 15 | — | — | 2 | — | — | 10 | — | — | — | — | — | — | 10 | — |
| | | (which is a | | | | | | | | | | | | | | | | | | | |
| | | product of | | | | | | | | | | | | | | | | | | | |
| | | TAYCA | | | | | | | | | | | | | | | | | | | |
| | | Cor- | | | | | | | | | | | | | | | | | | | |
| | | poration) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 50 nm | | | | | | | | | | | | | | | | | | | |
| | | “MPT141” | — | — | 10 | — | — | 15 | — | — | 2 | — | — | 10 | 10 | — | — | — | — | — | — |
| | | (which is a | | | | | | | | | | | | | | | | | | | |
| | | product of | | | | | | | | | | | | | | | | | | | |
| | | ISHIHARA | | | | | | | | | | | | | | | | | | | |
| | | SANGYO | | | | | | | | | | | | | | | | | | | |
| | | KAISHA, | | | | | | | | | | | | | | | | | | | |
| | | LTD.) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 100 nm | | | | | | | | | | | | | | | | | | | |
| | | “JA1” | — | — | — | — | — | — | — | — | — | — | — | — | — | 10 | — | — | — | — | — |
| | | (which is a | | | | | | | | | | | | | | | | | | | |
| | | product of | | | | | | | | | | | | | | | | | | | |
| | | TAYCA | | | | | | | | | | | | | | | | | | | |
| | | Cor- | | | | | | | | | | | | | | | | | | | |
| | | poration) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 180 nm | | | | | | | | | | | | | | | | | | | |
| | | “JA301” | — | — | — | — | — | — | — | — | — | — | — | — | — | — | 10 | — | — | — | — |
| | | (which is a | | | | | | | | | | | | | | | | | | | |
| | | product of | | | | | | | | | | | | | | | | | | | |
| | | TAYCA | | | | | | | | | | | | | | | | | | | |
| | | Cor- | | | | | | | | | | | | | | | | | | | |
| | | poration) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 300 nm | | | | | | | | | | | | | | | | | | | |
| | Silicon | “ST- | 10 | — | — | — | — | 15 | — | — | — | — | 2 | — | — | — | — | — | — | — | — |
| | oxide | CXS” | | | | | | | | | | | | | | | | | | | |
| | | (which is | | | | | | | | | | | | | | | | | | | |
| | | a product | | | | | | | | | | | | | | | | | | | |
| | | of Nissan | | | | | | | | | | | | | | | | | | | |
| | | Chemical | | | | | | | | | | | | | | | | | | | |
| | | Corpor- | | | | | | | | | | | | | | | | | | | |
| | | ation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 3 nm | | | | | | | | | | | | | | | | | | | |
| | | “ST-C” | — | 10 | — | — | — | — | 15 | — | — | — | — | 2 | — | — | — | — | — | — | 10 |
| | | (which is | | | | | | | | | | | | | | | | | | | |
| | | a product | | | | | | | | | | | | | | | | | | | |
| | | of Nissan | | | | | | | | | | | | | | | | | | | |
| | | Chemical | | | | | | | | | | | | | | | | | | | |
| | | Corpor- | | | | | | | | | | | | | | | | | | | |
| | | ation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 10 nm | | | | | | | | | | | | | | | | | | | |
| | | “ST-CM” | — | — | 10 | — | — | — | — | 15 | — | — | — | — | 2 | 2 | — | — | — | — | — |
| | | (which is | | | | | | | | | | | | | | | | | | | |
| | | a product | | | | | | | | | | | | | | | | | | | |
| | | of Nissan | | | | | | | | | | | | | | | | | | | |
| | | Chemical | | | | | | | | | | | | | | | | | | | |
| | | Corpor- | | | | | | | | | | | | | | | | | | | |
| | | ation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 20 nm | | | | | | | | | | | | | | | | | | | |
| | | “ST-YL” | — | — | — | 10 | — | — | — | — | 15 | — | — | — | — | — | 2 | — | — | — | — |
| | | (which is | | | | | | | | | | | | | | | | | | | |
| | | a product | | | | | | | | | | | | | | | | | | | |
| | | of Nissan | | | | | | | | | | | | | | | | | | | |
| | | Chemical | | | | | | | | | | | | | | | | | | | |
| | | Corpor- | | | | | | | | | | | | | | | | | | | |
| | | ation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 60 nm | | | | | | | | | | | | | | | | | | | |
| | | “MP- | — | — | — | — | 10 | — | — | — | — | 15 | — | — | — | — | — | 2 | — | — | — |
| | | 1040” | | | | | | | | | | | | | | | | | | | |
| | | (which is | | | | | | | | | | | | | | | | | | | |
| | | a product | | | | | | | | | | | | | | | | | | | |
| | | of Nissan | | | | | | | | | | | | | | | | | | | |
| | | Chemical | | | | | | | | | | | | | | | | | | | |
| | | Corpor- | | | | | | | | | | | | | | | | | | | |
| | | ation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 100 nm | | | | | | | | | | | | | | | | | | | |
| | | “MP- | — | — | — | — | — | — | — | — | — | — | — | — | — | — | — | — | 10 | — | — |
| | | 2040” | | | | | | | | | | | | | | | | | | | |
| | | (which is | | | | | | | | | | | | | | | | | | | |
| | | a product | | | | | | | | | | | | | | | | | | | |
| | | of Nissan | | | | | | | | | | | | | | | | | | | |
| | | Chemical | | | | | | | | | | | | | | | | | | | |
| | | Corpor- | | | | | | | | | | | | | | | | | | | |
| | | ation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 200 nm | | | | | | | | | | | | | | | | | | | |
| | | “MP- | — | — | — | — | — | — | — | — | — | — | — | — | — | — | — | — | — | 10 | — |
| | | 4540P” | | | | | | | | | | | | | | | | | | | |
| | | (which is | | | | | | | | | | | | | | | | | | | |
| | | a product | | | | | | | | | | | | | | | | | | | |
| | | of Nissan | | | | | | | | | | | | | | | | | | | |
| | | Chemical | | | | | | | | | | | | | | | | | | | |
| | | Corpor- | | | | | | | | | | | | | | | | | | | |
| | | ation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 450 nm | | | | | | | | | | | | | | | | | | | |
| | Resin | Urethane | 10 | 10 | — | — | — | 15 | — | — | — | 2 | — | — | — | — | 10 | — | — | — | 10 |
| | | resin | | | | | | | | | | | | | | | | | | | |
| | | Styrene- | — | — | 10 | — | — | — | 15 | — | — | — | 2 | — | — | — | — | 10 | — | — | — |
| | | acrylic | | | | | | | | | | | | | | | | | | | |
| | | resin | | | | | | | | | | | | | | | | | | | |
| | | Poly- | — | — | — | 10 | — | — | — | 15 | — | — | — | 2 | — | — | — | — | 10 | — | — |
| | | acrylic | | | | | | | | | | | | | | | | | | | |
| | | acid | | | | | | | | | | | | | | | | | | | |
| | | Polyester | — | — | — | — | 10 | — | — | — | 15 | — | — | — | — | 2 | — | — | — | 10 | — |
| | | resin | | | | | | | | | | | | | | | | | | | |
| | | Polyvinyl | — | — | — | — | — | — | — | — | — | — | — | — | 2 | — | — | — | — | — | — |
| | | alcohol | | | | | | | | | | | | | | | | | | | |
| | Solvent | 1,2- | 2 | 2 | 2 | 2 | 2 | 2 | 2 | 2 | 2 | 2 | 2 | 2 | 2 | 2 | 2 | 2 | 2 | 2 | 2 |
| | | Hexane- | | | | | | | | | | | | | | | | | | | |
| | | diol | | | | | | | | | | | | | | | | | | | |
| | | Glycerin | 5 | 5 | 5 | 5 | 5 | 5 | 5 | 5 | 5 | 5 | 5 | 5 | 5 | 5 | 5 | 5 | 5 | 5 | 5 |
| | | 2- | 2 | 2 | 2 | 2 | 2 | 2 | 2 | 2 | 2 | 2 | 2 | 2 | 2 | 2 | 2 | 2 | 2 | 2 | 2 |
| | | Pyrroli- | | | | | | | | | | | | | | | | | | | |
| | | done | | | | | | | | | | | | | | | | | | | |
| | | Propylene | 2 | 2 | 2 | 2 | 2 | 2 | 2 | 58 | 2 | 2 | 2 | 2 | 2 | 2 | 2 | 2 | 2 | 2 | 60 |
| | | glycol | | | | | | | | | | | | | | | | | | | |
| | | Water | 58 | 58 | 58 | 53 | 53 | 43 | — | — | 56 | 61 | 74 | 74 | 74 | 74 | 66 | 58 | 58 | 58 | — |
| | | Ethanol | — | — | — | — | — | — | 56 | — | — | — | — | — | — | — | — | — | — | — | — |
| | Poly- | “CARRY- | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| | carbo- | BON | | | | | | | | | | | | | | | | | | | |
| | xylic | L400” | | | | | | | | | | | | | | | | | | | |
| | acid | (which is | | | | | | | | | | | | | | | | | | | |
| | | a product | | | | | | | | | | | | | | | | | | | |
| | | of Sanyo | | | | | | | | | | | | | | | | | | | |
| | | Chemical | | | | | | | | | | | | | | | | | | | |
| | | Industries, | | | | | | | | | | | | | | | | | | | |
| | | Ltd.) | | | | | | | | | | | | | | | | | | | |
| | Sur- | OLFINE | 1 | 1 | 1 | 1 | 1 | 1 | 1 | 1 | 1 | 1 | 1 | 1 | 1 | 1 | 1 | 1 | 1 | 1 | 1 |
| | factant | (trade | | | | | | | | | | | | | | | | | | | |
| | | name) | | | | | | | | | | | | | | | | | | | |
| | | E1010 | | | | | | | | | | | | | | | | | | | |

| | | | | | | | | | | | | | | | | | | | |
|---|---|---|---|---|---|---|---|---|---|---|---|---|---|---|---|---|---|---|---|
| Content of titanium | 10 | 10 | 10 | 15 | 15 | 15 | 2 | 2 | 2 | 10 | 10 | 10 | 10 | 10 | 10 | 10 | 10 | 10 | 10 |
| oxide (% by mass) | | | | | | | | | | | | | | | | | | | |
| Content of silicon | 10 | 10 | 10 | 10 | 10 | 15 | 15 | 15 | 15 | 15 | 2 | 2 | 2 | 2 | 2 | 2 | 10 | 10 | 10 |
| oxide (% by mass) | | | | | | | | | | | | | | | | | | | |
| Content of resin (% | 10 | 10 | 10 | 10 | 10 | 15 | 15 | 15 | 15 | 2 | 2 | 2 | 2 | 2 | 10 | 10 | 10 | 10 | 10 |
| by mass) | | | | | | | | | | | | | | | | | | | |
| Average particle | 0.2 | 0.2 | 0.2 | 4 | 2 | 0.03 | 0.67 | 0.4 | 0.6 | 6.7 | 0.06 | 0.1 | 0.2 | 0.2 | 0.33 | 10 | 13.3 | 9 | 0.67 |
| diameter of silicon | | | | | | | | | | | | | | | | | | | |
| oxide/Average | | | | | | | | | | | | | | | | | | | |
| particle diameter of | | | | | | | | | | | | | | | | | | | |
| titanium oxide | | | | | | | | | | | | | | | | | | | |

TABLE 4

| | | | Exam- | Exam- | Exam- | Exam- | Exam- | Exam- | Exam- | Exam- | Exam- | Exam- | Exam- |
|---|---|---|---|---|---|---|---|---|---|---|---|---|---|
| | | | ple | ple | ple | ple | ple | ple | ple | ple | ple | ple | ple |
| | | | 21 | 22 | 23 | 24 | 25 | 26 | 27 | 28 | 29 | 30 | 31 |
| Evalu- | Stability to | | A | A | A | A | A | B | A | A | B | B | A |
| ation | precipitation | | | | | | | | | | | | |
| Re- | (Supernatant | | | | | | | | | | | | |
| sults | part) | | | | | | | | | | | | |
| | White- | Ratio | 1.30 | 1.30 | 1.30 | 1.30 | 1.30 | 1.10 | 1.20 | 1.20 | 1.20 | 1.30 | 1.30 |
| | ness | (L* | | | | | | | | | | | |
| | | after | | | | | | | | | | | |
| | | drying | | | | | | | | | | | |
| | | at | | | | | | | | | | | |
| | | 160° C./ | | | | | | | | | | | |
| | | L* after | | | | | | | | | | | |
| | | drying | | | | | | | | | | | |
| | | at a | | | | | | | | | | | |
| | | room | | | | | | | | | | | |
| | | tem- | | | | | | | | | | | |
| | | per- | | | | | | | | | | | |
| | | ature | | | | | | | | | | | |
| | | Evalu- | B | A | A | B | B | C | B | B | A | B | A |
| | | ation | | | | | | | | | | | |

| Water | A | A | A | A | A | A | A | A | A | A | A |
|---|---|---|---|---|---|---|---|---|---|---|---|
| resistance | | | | | | | | | | | |
| | | | | | | Com- | Com- | Com- | Com- | Com- | Com- |
| | | | | | | par- | par- | par- | par- | par- | par- |
| | | | | | | ative | ative | ative | ative | ative | ative |
| | | | | Exam- | Exam- | Exam- | Exam- | Exam- | Exam- | Exam- | Exam- |
| | | | | ple | ple | ple | ple | ple | ple | ple | ple |
| | | | | 32 | 33 | 21 | 22 | 23 | 24 | 25 | 26 |
| | Evalu- | Stability to | | B | B | C | C | B | C | C | B |
| | ation | precipitation | | | | | | | | | |
| | Re- | (Supernatant part) | | | | | | | | | |
| | sults | White- | Ratio | 1.30 | 1.30 | 1.00 | 1.00 | 1.10 | 1.00 | 1.00 | 1.00 |
| | | ness | (L* | | | | | | | | |
| | | | after | | | | | | | | |
| | | | drying | | | | | | | | |
| | | | at | | | | | | | | |
| | | | 160° C./ | | | | | | | | |
| | | | L* after | | | | | | | | |
| | | | drying | | | | | | | | |
| | | | at a | | | | | | | | |
| | | | room | | | | | | | | |
| | | | tem- | | | | | | | | |
| | | | per- | | | | | | | | |
| | | | ature | | | | | | | | |
| | | | Evalu- | A | A | A | A | D | B | B | D |
| | | | ation | | | | | | | | |

| | | | | | | | | |
|---|---|---|---|---|---|---|---|---|
| Water | A | B | A | A | A | A | A | A |
| resistance | | | | | | | | |

In the white pigment composition of each of Examples 21 to 33, which was obtained by combining the titanium oxide particles having an average particle diameter in a predetermined range, the silicon oxide particles having an average particle diameter in a predetermined range, and the resin, the stability to precipitation (the supernatant part) was evaluated as A or B. In addition, in each of these white pigment inks, the whiteness during drying was evaluated as A or B. From the above, it was confirmed that each of the white pigment inks can improve the non-precipitating property and the whiteness in good balance. On the other hand, it was confirmed that when the average particle diameter of the titanium oxide particles was too large as in Comparative Example 21 or 22, the non-precipitating property was not sufficient and when the average particle diameter of the titanium oxide particles was too small as in Comparative Example 23, the whiteness was not sufficient. In addition, it was confirmed that when the average particle diameter of the silicon oxide particles was too large as in Comparative Examples 24 and 25, the non-precipitating property was not sufficient. Further, it was confirmed that when the L₁*/L₂* was less than 1.1 as in Comparative Example 26, the whiteness was not sufficient.

Hereinafter, a third embodiment of the invention (hereinafter, referred to as “third embodiment”) will be described in detail, but the invention is not limited thereto, and various modifications can be made in a range not departing from the gist of the invention.

In the present specification, “stability to precipitation” refers to a property that precipitation of particles (particularly titanium oxide particles) included in a white pigment composition is suppressed and the particles exist stably. “Whiteness” refers to a property that when coating a coating medium (for example, a recording medium and matter to be painted) and drying the coated matter, brightness increases.

### White Pigment Composition

A white pigment composition of the third embodiment includes titanium oxide particles having an average particle diameter of 15 nm or more and 100 nm or less, silicon oxide particles having an average particle diameter of 3 nm or more and 100 nm or less, and a resin, in which, when the white pigment composition is put into a container having a columnar internal shape and is centrifuged at a centrifugal force of 100 G for 10 hours, there is no sediment in which a ratio of a thickness to a height of the entire white pigment composition is 0.025 or more. When the white pigment composition of the third embodiment has the configuration described above, both the stability to precipitation and the whiteness can be improved in good balance. Since the white pigment composition of the third embodiment can improve the stability to precipitation, for example, when used for a white ink or a white paint, storage stability is favorable, and when used for a white ink (for example, for a white ink of an ink jet method), dischargeability is favorable. In addition, since the white pigment composition of the third embodiment can improve the whiteness, even when used for both a white ink and a white paint, recorded matter and a coated article which have high whiteness can be obtained. Therefore, the white pigment composition of the third embodiment can be suitably used particularly for a white paint or a white ink (particularly, for a white ink used in an ink jet method).

Factors that such a white pigment composition can improve the stability to precipitation and the whiteness are considered as follows. However, the factors are not limited thereto. First, the inventors of the invention considered that as long as the whiteness can be improved when coating a coating medium (for example, a recording medium and matter to be painted) with a white pigment composition (for example, a white ink and a white paint) and heating and drying the coated matter, it is not necessarily need to improve whiteness of the white pigment composition (for example, a white ink and a white paint). Based on this consideration, during the intensive study, a white pigment composition was obtained by combining titanium oxide particles having an average particle diameter within a predetermined range, silicon oxide particles having an average particle diameter within a predetermined range, and a resin. In the coated matter obtained by coating the coating medium with the white pigment composition, when drying the coated matter, the constituent particles respectively agglomerate to form a nanocomposite, mainly due to the white pigment composition including the resin. Here, the silicon oxide particles, the titanium oxide particles, and the resin forming the white pigment composition have a high zeta potential (ζ potential) in this order in general, and when forming the nanocomposite, the components tend to agglomerate in order from a low zeta potential (ζ potential). That is, the resin, the titanium oxide particles, and silicon oxide particles agglomerate in this order to form the nanocomposite. It is considered that light reflection increases to obtain an effect of improving the whiteness, mainly due to the formation of the nanocomposite. Further, it is considered that an electric double layer collapses, inter-particle spacing decreases, and the whiteness remarkably improves, mainly due to a fact that the silicon oxide particles finally agglomerate to form the nanocomposite. Meanwhile, it is considered that, mainly due to a fact that the white pigment composition includes silicon oxide particles having a small particle diameter in a predetermined range and high negative chargeability, charge repulsion occurs, particles (particularly, titanium oxide particles) in the white pigment composition can exist stably by Brownian motion, and the stability to precipitation is improved.

The white pigment composition of the third embodiment can improve the whiteness of coated matter by drying the coated matter (for example, recorded matter and painted matter) obtained by coating a coating medium (for example, a recording medium and matter to be painted). The whiteness can be evaluated by measuring brightness (L*) in a CIE/L*a*b* color system, and high whiteness means that brightness (L*) is high.

The white pigment composition of the third embodiment can improve the stability to precipitation of particles (particularly, titanium oxide particles) in the white pigment composition. Therefore, when the white pigment composition is put into a container having a columnar internal shape and is centrifuged at a centrifugal force of 100 G for 10 hours, there is no sediment in which a ratio of a thickness to a height of the entire white pigment composition is 0.025 or more (preferably 0.023 or more and more preferably 0.021 or more).

An average particle diameter of particles included in the white pigment composition of the third embodiment is preferably 20 nm or more and 150 nm or less, more preferably 30 nm or more and 130 nm or less, and still more preferably 50 nm or more and 100 nm or less, from a viewpoint of further improving the stability to precipitation and the whiteness during heating and drying.

The white pigment composition of the third embodiment has, for example, a form in which particles are dispersed in an aqueous solvent. A pH of the white pigment composition is preferably 5.0 or more and 11.0 or less, more preferably 5.5 or more and 10.5 or less, and still more preferably 6.0 or more and 10.0 or less, from a viewpoint of further improving the stability to precipitation.

### Titanium Oxide Particle

The white pigment composition of the third embodiment includes titanium oxide particles. The titanium oxide particles may be, for example, modified titanium oxide particles of which surfaces are modified by a surface modifying agent and may also be unmodified titanium oxide particles.

A form of the titanium oxide particles is not particularly limited, and examples thereof include an amorphous form, an anatase type crystalline form, and a rutile type crystalline form. From a viewpoint of further improving covering power, the anatase type crystalline form is preferable.

As the titanium oxide particles, a commercially available product may be used. Examples of the commercially available product include “MT-01”, “MT-10EX”, “MT-05”, “MT-100S”, “MT-100TV”, “MT-100Z”, “MT-150EX”, “MT-150W”, “MT-100AQ”, “MT-100WP”, “MT-100SA”, “MT-100HD”, “MT-300HD”, “MT-500HD”, “MT-500B”, “MT-500SA”, “MT-600B”, “MT-600SA”, “MT-700B”, “MT-700HD”, “MTY-02”, “MTY-110M3S”, “MT-500SAS”, “MTY-700B S”, “JMT-1501B”, “JMT-150AO”, “JMT-150FI”, and “JMT-150ANO” (all are products of TAYCA Corporation), and “TTO-51(A)”, “TTO-51(C)”, “TTO-55(A)”, “TTO-55(B)”, “TTO-55(C)”, “TTO-55(D)”, “TTO-S-1”, “TTO-S-2”, “TTO-S-3”, “TTO-S-4”, “MPT-136”, “MPT-141”, “TTO-V-3”, “TTO-V-4”, “TTO-F-2”, “TTO-F-6”, and “TTO-W-5” (all are products of ISHIHARA SANGYO KAISHA, LTD.). One kind of these commercially available products can be used alone and two or more kinds thereof can be used in combination.

An average particle diameter of the titanium oxide particles of the third embodiment is 15 nm or more and 100 nm or less. When the average particle diameter is 15 nm or more, the whiteness can be improved. When the average particle diameter is 100 nm or less, the stability to precipitation can be improved. When the average particle diameter is within the above range, both the stability to precipitation and the whiteness can be improved in good balance. From the same viewpoint, the average particle diameter is preferably 30 nm or more and 100 nm or less, and more preferably 50 nm or more and 100 nm or less.

The average particle diameter of the titanium oxide particles in the present specification refers to a “50% average particle diameter (d50) in terms of sphere obtained by a dynamic light scattering method”. As a method of measuring the average particle diameter, for example, the following method can be used for measuring. Particles in a dispersion medium are irradiated with light, and the diffracted scattered light generated is measured by detectors disposed in front of, side of, and behind the dispersion medium. Using the obtained measurement values, assuming that the particles that are originally amorphous are spherical, a cumulative curve is obtained regarding a total volume of a group of particles converted into spheres having a volume equal to the volume of the particles as 100%. At this time, a point at which a cumulative value is 50% is calculated.

### Silicon Oxide Particle

The white pigment composition of the third embodiment includes silicon oxide particles. The silicon oxide particles of the third embodiment are not particularly limited, and examples thereof include fumed silica and colloidal silica. From a viewpoint of more effectively and reliably exhibiting the actions and effects of the invention, the colloidal silica is preferable. The term “colloidal silica” as used herein is a colloidal solution in which silica particles are dispersed in water, and refers to a concept including a modified colloidal silica which is modified due to modification of surfaces of silica particles by a modifying agent.

The colloidal silica may be prepared by a known method, and a commercially available product may also be used therefor. The commercially available product is not particularly limited, and examples thereof include SNOWTEX (trade name) ST-XS, SNOWTEX (trade name) ST-S, SNOWTEX (trade name) ST-30, SNOWTEX (trade name) ST-50, SNOWTEX (trade name) ST-30L, SNOWTEX (trade name) ST-XL, SNOWTEX (trade name) ST-YL, SNOWTEX (trade name) ST-ZL, SNOWTEX (trade name) MP-1040, SNOWTEX (trade name) MP-2040, SNOWTEX (trade name) MP-4540M, SNOWTEX (trade name) ST-UP, SNOWTEX (trade name) ST-PS-S, SNOWTEX (trade name) ST-PS-M, SNOWTEX (trade name) ST-OXS, SNOWTEX (trade name) ST-OS, SNOWTEX (trade name) ST-O, SNOWTEX (trade name) ST-O-40, SNOWTEX (trade name) ST-OL, SNOWTEX (trade name) ST-OYL, SNOWTEX (trade name) ST-OUP, SNOWTEX (trade name) ST-PS-SO, SNOWTEX (trade name) ST-PS-MO, SNOWTEX (trade name) ST-NXS, SNOWTEX (trade name) ST-NS, SNOWTEX (trade name) ST-N, SNOWTEX (trade name) ST-N-40, SNOWTEX (trade name) ST-CXS, SNOWTEX (trade name) ST-C, SNOWTEX (trade name) ST-CM, SNOWTEX (trade name) ST-AK-XS, SNOWTEX (trade name) ST-AK, SNOWTEX (trade name) ST-AK-L, SNOWTEX (trade name) ST-AK-YL, SNOWTEX (trade name) ST-AK-PS-S, SNOWTEX (trade name) ST-K2, SNOWTEX (trade name) LSS-35, SNOWTEX (trade name) LSS-45, SNOWTEX (trade name) PC-500, SNOWTEX (trade name) QAS-25, and SNOWTEX (trade name) QAS-40 (all are products of Nissan Chemical Corporation), and Klebosol 1498V-9, Klebosol 20H12, Klebosol 20H12E, Klebosol 30CAL25, Klebosol 30CAL50, Klebosol 30HB25K, Klebosol 30HB50K, Klebosol 30L12E, Klebosol 30N12, Klebosol 30R9, Klebosol 30R9BT, Klebosol 30R12C, Klebosol 30R25, Klebosol 30R50, Klebosol 30V9, Klebosol 30V12, Klebosol 30V25, Klebosol 30V50, Klebosol 40EA50, Klebosol 40R12, Klebosol 40R25, and Klebosol 50R50 (all are products of Clariant (Japan) K.K.). One kind of these commercially available products can be used alone and two or more kinds thereof can be used in combination.

An average particle diameter of the silicon oxide particles of the third embodiment is 3 nm or more and 100 nm or less. When the average particle diameter is within the above range, the whiteness and the stability to precipitation can be improved. From a viewpoint of further improving the whiteness and the stability to precipitation, the average particle diameter is preferably 3 nm or more and 50 nm or less, and more preferably 3 nm or more and 30 nm or less.

A method of measuring the average particle diameter of the silicon oxide particles is not particularly limited. For example, the average particle diameter of the silicon oxide particles can be measured by a method of calculating the average particle diameter from a relationship between a specific surface area obtained by a Sears method or a BET method and a density, a dynamic light scattering method, and a centrifugal precipitation method.

A ratio Dₐ/D_{b} between an average particle diameter Dₐ of the silicon oxide particles and an average particle diameter D_{b} of the titanium oxide particles is preferably less than 1. When the ratio Dₐ/D_{b} is less than 1, the whiteness tends to further be improved. From the same viewpoint, the ratio Dₐ/D_{b} is preferably 0.5 or less, and more preferably 0.4 or less.

### Resin

The white pigment composition of the third embodiment includes a resin. When including resin, the titanium oxide particles and silicon oxide particles can be agglomerated to form a nanocomposite during drying, and adhesion to the coating medium is excellent.

The resin may be an unmodified resin and may be a modified resin which has been modified with a modifier. The resin is not particularly limited, and examples thereof include one or more resins selected from the group consisting of a (meth)acrylic resin, a urethane resin, an epoxy resin, a polyimide resin, a polyamide resin, a polyvinyl alcohol resin, a cellulose resin, and a polyester resin. From a viewpoint of more effectively and reliably exhibiting the actions and effects of the invention, one or more resins selected from the group consisting of the (meth)acrylic resin, the urethane resin, the polyvinyl alcohol resin, and the polyester resin are preferable.

The (meth)acrylic resin is not particularly limited, and examples thereof include a polymer obtained from one or more acrylic monomers selected from the group consisting of (meth)acrylic acid, (meth)acrylic acid ester, acrylonitrile, cyanoacrylate, and acrylamide. The (meth)acrylic resin may be a homopolymer of the acrylic monomers described above, and may be a copolymer of the acrylic monomer described above and another monomer copolymerizable with the acrylic monomer. The other monomer is not particularly limited, and examples thereof include one or more selected from the group consisting of styrene, olefin, vinyl acetate, vinyl chloride, vinyl alcohol, vinyl ether, vinyl pyrrolidone, vinyl pyridine, vinyl carbazole, vinyl imidazole, and vinylidene chloride. A type of bonding of the copolymer described above is not particularly limited, and examples thereof include random, block, alternating, and graft.

The urethane resin is not particularly limited, and examples thereof include a polymer obtained by reacting a polyisocyanate and a polyol by a known method. The polyisocyanate is not particularly limited, and examples thereof include linear, branched, or cyclic aliphatic isocyanate and aromatic isocyanate. One kind of these polyisocyanates can be used alone and two or more kinds thereof can be used in combination. The polyol is not particularly limited, and examples thereof include a polyether polyol (for example, polyethylene glycol, polypropylene glycol, and polytetramethylene glycol), and a polycarbonate polyol (for example, a reaction product of diols with dimethyl alkyl carbonate or cyclic carbonate). One kind of these polyols can be used alone and two or more kinds thereof can be used in combination.

The polyvinyl alcohol resin is not particularly limited, and examples thereof include a polymer obtained from vinyl acetate. The polyvinyl alcohol may be a homopolymer of vinyl acetate (polyvinyl alcohol) and may also be a copolymer of vinyl acetate and another monomer other than the acrylic monomer, copolymerizable with vinyl acetate. A type of bonding of the copolymer described above is not particularly limited, and examples thereof include random, block, alternating, and graft. One kind of these polyvinyl alcohols can be used alone and two or more kinds thereof can be used in combination.

The polyester resin is not particularly limited, and examples thereof include polybutylene terephthalate, polytrimethylene terephthalate, polyethylene terephthalate, polyethylene naphthalate, and copolymers thereof. One kind of these polyester resins can be used alone and two or more kinds thereof can be used in combination.

A form of these resins is not particularly limited, for example, may be a suspension form or an emulsion form.

Among these, from a viewpoint of further improving the stability to precipitation and the whiteness, at least one selected from the group consisting of a urethane resin, a styrene-acrylic resin (styrene-acrylic copolymer), polyacrylic acid, a polyvinyl alcohol, and a polyester resin is preferable. From a viewpoint of further improving water resistance of coated matter (for example, recorded matter), at least one selected from the group consisting of the urethane resin, the styrene-acrylic resin, the polyacrylic acid, and the polyester resin is more preferable.

An average particle diameter of the resin is preferably 20 nm or more and 200 nm or less, more preferably 30 nm or more and 180 nm or less, and still more preferably 50 nm or more and 150 nm or less, from a viewpoint of further improving the stability to precipitation and the whiteness. The average particle diameter of the resin refers to a “50% average particle diameter (d50) in terms of sphere obtained by a dynamic light scattering method”, and can be calculated by the same method as the calculation method described in the section of the average particle diameter of the titanium oxide particles.

Each content of the titanium oxide particles, the silicon oxide particles, and the resin of the third embodiment is preferably 2% by mass or more and 15% by mass or less, more preferably 3% by mass or more and 12% by mass or less, and still more preferably 5% by mass or more and 10% by mass or less, with respect to the entire white pigment composition (100% by mass), from a viewpoint of further improving the stability to precipitation and the whiteness. Each content of the titanium oxide particles, the silicon oxide particles, and the resin is a content when converted into a solid content, and the same is applied in the following. In addition, each content is indicated by an integer value rounded off to the decimal point.

In addition, each of a ratio of the content of the silicon oxide particles to the content of the titanium oxide particles of the third embodiment, a ratio of the content of the resin to the content of the titanium oxide particles, and a ratio of the content of the resin to the content of the silicon oxide particles is preferably 0.2 or more and 7.5 or less, more preferably 0.5 or more and 5.0 or less, and still more preferably 1.0 or more and 3.0 or less, from a viewpoint of further improving the stability to precipitation and the whiteness.

### Solvent

The white pigment composition of the third embodiment may further include a solvent. Examples of the solvent include water and an organic solvent.

The water is not particularly limited, and examples thereof include ion exchanged water, ultrafiltered water, reverse osmosis water, distilled water, and ultrapure water.

The organic solvent is not particularly limited, and examples thereof include alcohols or glycols such as glycerin, ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, 1,6-hexanediol, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol monobutyl ether, diethylene glycol mono-t-butyl ether, propylene glycol monomethyl ether, propylene glycol monoethyl ether, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, dipropylene glycol mono-iso-propyl ether, diethylene glycol dimethyl ether, diethylene glycol diethyl ether, diethylene glycol dibutyl ether, diethylene glycol ethyl methyl ether, diethylene glycol butyl methyl ether, triethylene glycol dimethyl ether, tetraethylene glycol dimethyl ether, dipropylene glycol dimethyl ether, dipropylene glycol diethyl ether, tripropylene glycol dimethyl ether, methanol, ethanol, n-propyl alcohol, iso-propyl alcohol, n-butanol, 2-butanol, tert-butanol, iso-butanol, n-pentanol, 2-pentanol, 3-pentanol, and tert-pentanol, N,N-dimethylformamide, N,N-dimethylacetamide, 2-pyrrolidone, N-methyl-2-pyrrolidone, 2-oxazolidone, 1,3-dimethyl-2-imidazolidinone, dimethyl sulfoxide, sulfolane, and 1,1,3,3-tetramethylurea. One kind of these solvents can be used alone and two or more kinds thereof can be used in combination.

Among these solvents, it is preferable that water and at least one selected from the group consisting of organic solvents having a boiling point of 190° C. or lower (preferably having a boiling point of 185° C. or lower and more preferably having a boiling point of 180° C. or lower) (hereinafter also referred to as a “specific organic solvent”) be included, from a viewpoint of further improving the whiteness. Specific examples of the organic solvent having a boiling point of 190° C. or lower include ethylene glycol (boiling point: 197° C.; hereinafter numbers in parentheses indicate boiling points), triethylene glycol (125° C.), propylene glycol (188° C.), ethylene glycol mono-iso-propyl ether (144° C.), ethylene glycol mono-n-butyl ether (171° C.), propylene glycol monomethyl ether (121° C.), propylene glycol monoethyl ether (132° C.), propylene glycol mono-t-butyl ether (171° C.), propylene glycol mono-n-propyl ether (149° C.), propylene glycol mono-n-butyl ether (170° C.), diethylene glycol dimethyl ether (162° C.), diethylene glycol diethyl ether (188° C.), diethylene glycol ethyl methyl ether (179° C.), dipropylene glycol dimethyl ether (175° C.), methanol (65° C.), ethanol (78° C.), n-propyl alcohol (82° C.), iso-propyl alcohol (82° C.), n-butanol (117° C.), 2-butanol (99° C.), tert-butanol (82° C.), iso-butanol (108° C.), n-pentanol (138° C.), 2-pentanol (119° C.), 3-pentanol (114° C.), N,N-dimethylformamide (153° C.), N,N-dimethylacetamide (165° C.), dimethyl sulfoxide (189° C.), and 1,1,3,3-tetramethylurea (177° C.).

Among these organic solvents, it is preferable that the organic solvent be one or more selected from the group consisting of glycerin, ethylene glycol, diethylene glycol, triethylene glycol, 2-pyrrolidone, N-methyl-2-pyrrolidone, 1,3-propanediol, 1,4-butanediol, and 1,5-pentanediol, from a viewpoint of functioning as a moisturizing agent. Hereinafter, these organic solvents are also referred to as a moisturizing agent.

Among these organic solvents, it is preferable that the organic solvent be one or more selected from the group consisting of ethylene glycol monomethyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol monobutyl ether, diethylene glycol mono-t-butyl ether, propylene glycol monomethyl ether, propylene glycol monoethyl ether, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, dipropylene glycol mono-iso-propyl ether, diethylene glycol dimethyl ether, diethylene glycol diethyl ether, diethylene glycol dibutyl ether, diethylene glycol ethyl methyl ether, diethylene glycol butyl methyl ether, triethylene glycol dimethyl ether, tetraethylene glycol dimethyl ether, dipropylene glycol dimethyl ether, dipropylene glycol diethyl ether, tripropylene glycol dimethyl ether, 1,2-hexanediol, and 2-pyrrolidone, from a viewpoint of functioning as a penetrating agent. Hereinafter, these organic solvents are also referred to as a penetrating agent.

A content of the solvent in the white pigment composition of the third embodiment is preferably 50% by mass or more (for example, 50% by mass or more and 85% by mass or less), more preferably 55% by mass or more, and still more preferably 60% by mass or more, with respect to the entire white pigment composition (100% by mass), from a viewpoint of more effectively and reliably exhibiting the actions and effects of the invention.

A content of the moisturizing agent in the white pigment composition of the third embodiment is preferably 1% by mass or more and 10% by mass or less with respect to the entire white pigment composition (100% by mass), from a viewpoint of more effectively and reliably exhibiting the actions and effects of the invention. A content of the penetrating agent is preferably 1% by mass or more and 3% by mass or less, from a viewpoint of more effectively and reliably exhibiting the actions and effects of the invention.

A content of the moisture in the white pigment composition of the third embodiment is preferably 50% by mass or more (for example, 50% by mass or more and 75% by mass or less), more preferably 53% by mass or more, and still more preferably 55% by mass or more, with respect to the entire white pigment composition (100% by mass), from a viewpoint of further improving the whiteness. A total content of the water and the specific organic solvent in the white pigment composition of the third embodiment is preferably 45% by mass or more (for example, 45% by mass or more and 80% by mass or less), more preferably 50% by mass or more, and still more preferably 55% by mass or more, with respect to the entire white pigment composition (100% by mass), from a viewpoint of further improving the whiteness.

### Polycarboxylic Acid

The white pigment composition of the third embodiment preferably includes polycarboxylic acid, from a viewpoint of more stably dispersing the particles (particularly, titanium oxide particles) in the white pigment composition. The polycarboxylic acid may be low molecular weight polycarboxylic acid and may also be polymeric polycarboxylic acid. As the polycarboxylic acid, those commercially available as a dispersant can generally be used. Examples of the commercially available product include “CARRYBON L-400” and “SANSPARL PS-2” (both are products of Sanyo Chemical Industries, Ltd.) and “DEMOL EP” and “DEMOL P” (both are products of Kao Corporation). One kind of these polycarboxylic acids can be used alone and two or more kinds thereof can be used in combination.

A content of the polycarboxylic acid is preferably more than 0% by mass and 1% by mass or less, in terms of solid content, with respect to the entire white pigment composition (100% by mass), from a viewpoint of more effectively and reliably exhibiting the actions and effects of the invention.

In the white pigment composition of the third embodiment, it is preferable that a pH of the white pigment composition be 5 or more and 11 or less and the white pigment composition include the polycarboxylic acid, from a viewpoint of further improving the stability to precipitation.

### Surfactant

The white pigment composition of the third embodiment preferably includes a surfactant, from a viewpoint of further improving wettability of the white pigment composition with which a coating medium (for example, a recording medium) is coated. The surfactant is not particularly limited, and examples thereof include an acetylene glycol surfactant, a fluorine surfactant, and a silicone surfactant. One kind of these surfactants can be used alone and two or more kinds thereof can be used in combination. Among these, the acetylene glycol surfactant is preferable, from a viewpoint of further improving the wettability. The acetylene glycol surfactant is not particularly limited, and examples thereof include OLFINE (trade name) 104 series, OLFINE E series such as OLFINE E1010, SURFYNOL (trade name) 465, SURFYNOL (trade name) 61, and SURFYNOL (trade name) DF110D (all are products of Nissin Chemical Industry Co., Ltd.). One kind of these acetylene glycol surfactants can be used alone and two or more kinds thereof can be used in combination.

A content of the surfactant may be, for example, more than 0% by mass and 1% by mass or less, with respect to the entire white pigment composition (100% by mass).

In addition, the white pigment composition of the third embodiment may further include an additive other than the above components. Examples of the additive include a recording medium dissolving agent, a nozzle clogging preventing agent, a preservative, an antioxidant, a conductivity regulator, a pH adjuster, a viscosity modifier, a surface tension regulator, and an oxygen absorber. One kind of these additives may be used alone and two or more kinds thereof may be used in combination.

### Dried Object

A dried object of the third embodiment has a dried form of the white pigment composition of the third embodiment. The dried object of the third embodiment has a high whiteness. Therefore, when using the dried object of the third embodiment, coated matter (for example, recorded matter and painted matter) with excellent whiteness can be obtained.

### Coated Matter

Coated matter of the third embodiment includes a coating medium and the dried object of the third embodiment, with which the coating medium is coated. Since the coated matter of the third embodiment includes the dried object with high whiteness, the coated matter can be suitably used particularly as recorded matter and painted matter. In a case where the coated matter is recorded matter, the recorded matter includes a recording medium and the dried object of the third embodiment, with which recording is performed on the recording medium. In a case where the coated matter is painted matter, the painted matter includes matter to be painted and the dried object of the third embodiment, with which the matter to be painted is painted.

In a case of using the coated matter as the recorded matter, the recording medium is not particularly limited, and examples thereof include paper, cardboard, a textile product, a sheet or a film, plastic, glass, and ceramics. In a case of using the coated matter as the painted matter, the matter to be painted is not particularly limited, and examples thereof include a cement base material such as concrete and mortar, a metal base material such as steel material, glass, cloth, wood, a resin film, tile, and synthetic or natural leather. Examples of painted matter include a part for a vehicle, a household appliance, a building material, furniture, tableware, shoes, a bag, a leather accessory, clothing, and a hand stock for handicraft.

### Coating Method

A coating method of the third embodiment includes a coating step of coating a coating medium with the white pigment composition of the third embodiment and a drying step of drying the coating medium coated with the white pigment composition. FIG. 1 is a flowchart showing an example of the coating method of the third embodiment. In the coating method of the third embodiment, since the white pigment composition of the third embodiment, which is excellent in stability to precipitation, is used, the coating medium can be uniformly coated with the white pigment composition. In addition, when drying the coating medium coated with the white pigment composition which is excellent in whiteness, white coated matter having high brightness can be formed.

### Coating Step

In the coating step of the third embodiment, the coating medium is coated with the white pigment composition of the third embodiment. In a case where the coating medium is the matter to be painted, the coating method (a painting method) is not particularly limited, and examples thereof include a brush coating method, a spray method, a dipping method, a flow coating method, and a spin coating method.

### Drying Step

In a heating and drying step of the third embodiment, the coating medium coated with the white pigment composition of the third embodiment is heated and dried. A heating temperature is not particularly limited, for example, is a room temperature (for example, 25° C.) to 250° C. From a viewpoint of further improving the whiteness, the heating temperature is preferably 50° C. to 220° C. and more preferably 100° C. to 200° C. Heating time is not particularly limited, and may be, for example, approximately 1 to 60 minutes.

### Ink Jet Recording Method

An ink jet recording method of the third embodiment includes a discharging step of discharging the white pigment composition of the third embodiment to a recording medium by an ink jet method to coat the recording medium and a drying step of drying the recording medium coated with the white pigment composition. FIG. 2 is a flowchart showing an example of the ink jet recording method of the third embodiment. In the ink jet recording method of the third embodiment, since the white pigment composition of the third embodiment, which is excellent in stability to precipitation, is used, dischargeability is excellent and the recording medium can be uniformly coated with the white pigment composition. In addition, when drying the recording medium coated with the white pigment composition of the third embodiment, white recorded matter having high brightness can be formed.

### Discharging Step

In the discharging step of the third embodiment, the white pigment composition of the third embodiment is discharged to a recording medium by an ink jet method to coat the recording medium. Examples of the recording medium include the recording medium exemplified in the section of “Coated Matter”. The ink jet method is not particularly limited, and examples thereof include a thermal jet ink jet, a piezo ink jet, a continuous ink jet, a roller application, and a spray application.

### Drying Step

In a heating and drying step of the third embodiment, the recording medium coated with the white pigment composition of the third embodiment is heated and dried. A heating temperature is not particularly limited, for example, is a room temperature (for example, 25° C.) to 250° C. From a viewpoint of further improving the whiteness, the heating temperature is preferably 50° C. to 220° C. and more preferably 100° C. to 200° C. Heating time is not particularly limited, and may be, for example, approximately 1 to 60 minutes.

### Ink Jet Printer (Ink Jet Recording Device)

An ink jet printer (also referred to as an “ink jet recording device”) of the third embodiment is an ink jet printer that discharges an ink from an ink jet head, and the ink is the white pigment composition of the third embodiment. In the ink jet printer of the third embodiment, since the white pigment composition of the third embodiment, which is excellent in stability to precipitation, is discharged as an ink from the ink jet head, dischargeability is excellent and when drying, white recorded matter having high brightness can be obtained.

The ink jet printer of the third embodiment preferably includes a drying device for drying a recording medium to which the ink is attached.

FIG. 3 is a schematic side view showing an example of the ink jet printer of the third embodiment. An ink jet printer 1 of the third embodiment includes a setting unit 2 for setting a roll-shaped recording medium P, a transport unit 3 that transports the recording medium P in a transport direction A, a recording unit 4 that is formed on an upstream side in the transport direction A and performs recording on the recording medium P with an ink, a dryer 5 that is formed on a downstream side of the transport direction A and dries the recording medium P on which recording has been performed with the ink, and a winding unit 6 that is formed on a further downstream side of the transport direction A and winds and recovers the dried recording medium P while rotating in a rotation direction C.

### Setting Unit 2

The setting unit 2 is rotatable in the rotation direction C when transport unit 3 transports the recording medium P to the transport direction A.

### Transport Unit 3

The transport unit 3 includes a plurality of transporting rollers (not shown) and can transport the recording medium P to the transport direction A via the plurality of transporting rollers.

### Recording Unit 4

The recording unit 4 includes a recording head 11 and a platen 12 that faces the recording head 11 and supports a roll-shaped recording medium P. The recording head 11 includes an ink container (not shown) containing the white pigment composition (white pigment ink) of the third embodiment and a plurality of nozzles (not shown). When the recording medium P supported by the platen 12 faces the recording head 11, an ink is discharged from holes of the plurality of nozzles of the recording head 11 toward the recording medium P and recording is performed. Scanning is performed with the recording head 11 back and forth in the scanning direction B intersecting the transport direction A to perform recording.

### Dryer 5

The dryer 5 includes a heater 13 capable of heating by performing irradiation with electromagnetic waves (for example, infrared rays). The recording medium P on which recording has been performed with the ink can be dried.

### Winding Unit 6

The winding unit 6 is rotatable in the rotation direction C when winding the recording medium P.

Next, an example of a recording method using the ink jet printer 1 shown in FIG. 3 will be described. First, the roll-shaped recording medium P is set to the setting unit 2. Next, the recording medium P is transported toward the recording unit 4 toward the transport direction A by the transport unit 3. When the recording medium P is supported by the platen 12 and faces the recording head 11, the white pigment ink contained in the ink container of the recording head 11 is discharged from the holes of the plurality of nozzles toward the recording medium P and recording is performed. Scanning is performed with the recording head 11 back and forth in the scanning direction B intersecting the transport direction A to perform recording. Next, the recording medium P on which recording has been performed is transported toward the dryer by the transport unit 3, and the recording medium P on which recording has been performed with an ink is heated and dried by the heater 13 of the dryer 5. Next, the heated and dried recording medium P is wound by the winding unit 6, whereby the recording medium P can be recovered.

In the ink jet printer of the third embodiment, for example, an appropriate configuration may be added to the ink jet printer 1 shown in FIG. 3, and for example, a configuration of recording devices described in JP-A-2014-172285, JP-A-2015-150823, and JP-A-2016-107469 may be added thereto.

### EXAMPLES

Hereinafter, an embodiment of the invention will be described more specifically using Examples, but the third embodiment is not limited to these Examples.

### Preparation of White Pigment Composition (White Pigment Ink)

Components shown in Table 5 were added to a container so as to have a composition shown in Table 5 (in Table 5, a number without a unit represents “part by mass”, and a numerical value of each content is a content with respect to the entire white pigment ink and rounded off to the decimal point.), mixed and stirred at a normal temperature, and filtered with a membrane filter having a pore size of 5 μm to obtain the white pigment compositions (white pigment inks) of Examples 41 to 53 and Comparative Examples 41 to 45.

With respect to the obtained white pigment compositions of Examples 41 to 53 and Comparative Examples 41 to 45, respective physical properties thereof were evaluated based on the following evaluation method.

1. Average Particle Diameter of Particles included in White Pigment Ink

The average particle diameter (median diameter) of the particles included in the white pigment ink of each of Examples 41 to 53 was measured by a dynamic light scattering method. As a pretreatment, each white pigment ink was diluted with water and the obtained solution was used for measurement. As a measuring machine, a dynamic light scattering type particle diameter distribution measuring device “LB-550” (a product of HORIBA. Ltd.) was used. As a result of the measurement, the average particle diameter of the particles included in the white pigment ink of each of Examples 41 to 53 was approximately 20 to 150 nm.

### 2. Stability to Precipitation

Each white pigment ink was put into a sample container having a cylindrical internal shape to have a depth (height) of 24 mm and was centrifuged at a centrifugal force of 100 G for 10 hours. In this state, a depth (height) of a transparent supernatant part resulting from the precipitation of the white pigment was measured and the stability to precipitation of each white pigment composition was evaluated from the measurement value in accordance with the following evaluation criteria. Next, the sample container in which centrifugation was performed was tilted by 90 degrees to remove a liquid part of the white pigment ink. Thereafter, in the state where the sample container was tilted by 90 degrees to restore the container to the original state, the presence or absence of sediment (precipitate having lost flowability) at the bottom of the sample container was confirmed. In a case where the sediment was observed, a thickness of the sediment from the bottom was measured.

### Evaluation Criteria

A: The depth (height) of the supernatant part was 1 mm or less.

B: The depth (height) of the supernatant part was more than 1 mm and 5 mm or less.

C: The depth (height) of the supernatant part was more than 5 mm and less than 12 mm.

D: The depth (height) of the supernatant part was 12 mm or more.

### 3. Whiteness

An ink tank of an ink jet printer (“PX-M870G930” which is a product of Seiko Epson Corporation) was filled with each white pigment composition, and printing was performed on “Lumirror (R) S10-100 μm” (manufactured by Toray Industries. Inc., a commercially available PET sheet having no ink receiving layer) with a resolution of 1200×1200 dpi and a solid pattern of 100% duty to obtain two sheets of recorded matter. Next, one recorded matter was dried by heating at 160° C. for 5 minutes, and the other recorded matter was dried by standing for 1 day at a room temperature (23° C.). Next, with respect to the two types of the dried recorded matter, L* values in a CIE/L*a*b* color system were measured using a commercially available colorimeter with a black substrate (“Gretag Macbeth Spetroscan and Spectrolino” which is a product of X-Rite, Incorporated.).

The whiteness of each white pigment composition was evaluated, using the L* value obtained after drying at 160° C. for 5 minutes, in accordance with the following evaluation criteria.

### Evaluation Criteria

A: The L* value was 75 or more.

B: The L* value was 70 or more and less than 75.

C: The L* value was 60 or more and less than 70.

D: The L* value was less than 60.

### 4. Water Resistance

The recorded matter dried at 160° C. for 5 minutes in “3. Whiteness” was allowed to penetrate into 40° C. of hot water for 1 hour. The presence or absence of a color change was visually confirmed and the water resistance was evaluated in accordance with the following evaluation criteria.

### Evaluation Criteria

A: No color change was seen.

B: A color change was seen.

TABLE 5
In Table 5, numerical values of the titanium oxide, the silicon oxide, and the resin represent values of solid contents.

| | | | | | | | | | | | | | | | | Com- | Com- | Com- | Com- | Com- | Com- |
|---|---|---|---|---|---|---|---|---|---|---|---|---|---|---|---|---|---|---|---|---|---|
| | | | | | | | | | | | | | | | | par- | par- | par- | par- | par- | par- |
| | | | | | | | | | | | | | | | | ative | ative | ative | ative | ative | ative |
| | | | | | | | | | | | | | | | | Ex- | Ex- | Ex- | Ex- | Ex- | Ex- |
| | | | | | | | | | | | | | Exam- | Exam- | Exam- | am- | am- | am- | am- | am- | am- |
| | | | Example | Example | Example | Example | Example | Example | Example | Example | Example | Example | ple | ple | ple | ple | ple | ple | ple | ple | ple |
| | | | 41 | 42 | 43 | 44 | 45 | 46 | 47 | 48 | 49 | 50 | 51 | 52 | 53 | 41 | 42 | 43 | 44 | 45 | 46 |
| White | Titanium oxide | “MT05” | — | — | — | — | — | — | — | — | — | — | — | — | — | — | — | 10 | — | — | — |
| pig- | | (which is | | | | | | | | | | | | | | | | | | | |
| ment- | | a product | | | | | | | | | | | | | | | | | | | |
| compo- | | of TAYCA | | | | | | | | | | | | | | | | | | | |
| sition | | Corporation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 10 nm | | | | | | | | | | | | | | | | | | | |
| | | “MT100WP” | 10 | — | — | 15 | — | — | 2 | — | — | 10 | — | — | — | — | — | — | 10 | — | 10 |
| | | (which is a | | | | | | | | | | | | | | | | | | | |
| | | product of | | | | | | | | | | | | | | | | | | | |
| | | TAYCA | | | | | | | | | | | | | | | | | | | |
| | | Corporation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 15 nm | | | | | | | | | | | | | | | | | | | |
| | | “MT600B” | — | 10 | — | — | 15 | — | — | 2 | — | — | 10 | — | — | — | — | — | — | 10 | — |
| | | (which is a | | | | | | | | | | | | | | | | | | | |
| | | product of | | | | | | | | | | | | | | | | | | | |
| | | TAYCA | | | | | | | | | | | | | | | | | | | |
| | | Corporation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 50 nm | | | | | | | | | | | | | | | | | | | |
| | | “MPT141” | — | — | 10 | — | — | 15 | — | — | 2 | — | — | 10 | 10 | — | — | — | — | — | — |
| | | (which is a | | | | | | | | | | | | | | | | | | | |
| | | product of | | | | | | | | | | | | | | | | | | | |
| | | ISHIHARA | | | | | | | | | | | | | | | | | | | |
| | | SANGYO | | | | | | | | | | | | | | | | | | | |
| | | KAISHA, | | | | | | | | | | | | | | | | | | | |
| | | LTD.) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 100 nm | | | | | | | | | | | | | | | | | | | |
| | | “JA1” | — | — | — | — | — | — | — | — | — | — | — | — | — | 10 | — | — | — | — | — |
| | | (which is a | | | | | | | | | | | | | | | | | | | |
| | | product of | | | | | | | | | | | | | | | | | | | |
| | | TAYCA | | | | | | | | | | | | | | | | | | | |
| | | Corporation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 180 nm | | | | | | | | | | | | | | | | | | | |
| | | “JA301” | — | — | — | — | — | — | — | — | — | — | — | — | — | — | 10 | — | — | — | — |
| | | (which is a | | | | | | | | | | | | | | | | | | | |
| | | product of | | | | | | | | | | | | | | | | | | | |
| | | TAYCA | | | | | | | | | | | | | | | | | | | |
| | | Corporation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 300 nm | | | | | | | | | | | | | | | | | | | |
| | Silicon | “ST- | 10 | — | — | — | — | 15 | — | — | — | — | 2 | — | — | — | — | — | — | — | — |
| | oxide | CXS” | | | | | | | | | | | | | | | | | | | |
| | | (which is | | | | | | | | | | | | | | | | | | | |
| | | a product | | | | | | | | | | | | | | | | | | | |
| | | of Nissan | | | | | | | | | | | | | | | | | | | |
| | | Chemical | | | | | | | | | | | | | | | | | | | |
| | | Corpor- | | | | | | | | | | | | | | | | | | | |
| | | ation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 3 nm | | | | | | | | | | | | | | | | | | | |
| | | “ST-C” | — | 10 | — | — | — | — | 15 | — | — | — | — | 2 | — | — | — | — | — | — | 10 |
| | | (which is | | | | | | | | | | | | | | | | | | | |
| | | a product | | | | | | | | | | | | | | | | | | | |
| | | of Nissan | | | | | | | | | | | | | | | | | | | |
| | | Chemical | | | | | | | | | | | | | | | | | | | |
| | | Corpor- | | | | | | | | | | | | | | | | | | | |
| | | ation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 10 nm | | | | | | | | | | | | | | | | | | | |
| | | “ST-CM” | — | — | 10 | — | — | — | — | 15 | — | — | — | — | 2 | 2 | — | — | — | — | — |
| | | (which is | | | | | | | | | | | | | | | | | | | |
| | | a product | | | | | | | | | | | | | | | | | | | |
| | | of Nissan | | | | | | | | | | | | | | | | | | | |
| | | Chemical | | | | | | | | | | | | | | | | | | | |
| | | Corpor- | | | | | | | | | | | | | | | | | | | |
| | | ation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 20 nm | | | | | | | | | | | | | | | | | | | |
| | | “ST-YL” | — | — | — | 10 | — | — | — | — | 15 | — | — | — | — | — | 2 | — | — | — | — |
| | | (which is | | | | | | | | | | | | | | | | | | | |
| | | a product | | | | | | | | | | | | | | | | | | | |
| | | of Nissan | | | | | | | | | | | | | | | | | | | |
| | | Chemical | | | | | | | | | | | | | | | | | | | |
| | | Corpor- | | | | | | | | | | | | | | | | | | | |
| | | ation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 60 nm | | | | | | | | | | | | | | | | | | | |
| | | “MP- | — | — | — | — | 10 | — | — | — | — | 15 | — | — | — | — | — | 2 | — | — | — |
| | | 1040” | | | | | | | | | | | | | | | | | | | |
| | | (which is | | | | | | | | | | | | | | | | | | | |
| | | a product | | | | | | | | | | | | | | | | | | | |
| | | of Nissan | | | | | | | | | | | | | | | | | | | |
| | | Chemical | | | | | | | | | | | | | | | | | | | |
| | | Corpor- | | | | | | | | | | | | | | | | | | | |
| | | ation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 100 nm | | | | | | | | | | | | | | | | | | | |
| | | “MP- | — | — | — | — | — | — | — | — | — | — | — | — | — | — | — | — | 10 | — | — |
| | | 2040” | | | | | | | | | | | | | | | | | | | |
| | | (which is | | | | | | | | | | | | | | | | | | | |
| | | a product | | | | | | | | | | | | | | | | | | | |
| | | of Nissan | | | | | | | | | | | | | | | | | | | |
| | | Chemical | | | | | | | | | | | | | | | | | | | |
| | | Corpor- | | | | | | | | | | | | | | | | | | | |
| | | ation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 200 nm | | | | | | | | | | | | | | | | | | | |
| | | “MP- | — | — | — | — | — | — | — | — | — | — | — | — | — | — | — | — | — | 10 | — |
| | | 4540P” | | | | | | | | | | | | | | | | | | | |
| | | (which is | | | | | | | | | | | | | | | | | | | |
| | | a product | | | | | | | | | | | | | | | | | | | |
| | | of Nissan | | | | | | | | | | | | | | | | | | | |
| | | Chemical | | | | | | | | | | | | | | | | | | | |
| | | Corpor- | | | | | | | | | | | | | | | | | | | |
| | | ation) | | | | | | | | | | | | | | | | | | | |
| | | Average | | | | | | | | | | | | | | | | | | | |
| | | particle | | | | | | | | | | | | | | | | | | | |
| | | diameter: | | | | | | | | | | | | | | | | | | | |
| | | 450 nm | | | | | | | | | | | | | | | | | | | |
| | Resin | Urethane | 10 | 10 | — | — | — | 15 | — | — | — | 2 | — | — | — | — | 10 | — | — | — | 10 |
| | | resin | | | | | | | | | | | | | | | | | | | |
| | | Styrene- | — | — | 10 | — | — | — | 15 | — | — | — | 2 | — | — | — | — | 10 | — | — | — |
| | | acrylic | | | | | | | | | | | | | | | | | | | |
| | | resin | | | | | | | | | | | | | | | | | | | |
| | | Poly- | — | — | — | 10 | — | — | — | 15 | — | — | — | 2 | — | — | — | | 10 | — | — |
| | | acrylic acid | | | | | | | | | | | | | | | | | | | |
| | | Polyester | — | — | — | — | 10 | — | — | — | 15 | — | — | — | — | 2 | — | — | — | 10 | — |
| | | resin | | | | | | | | | | | | | | | | | | | |
| | | Polyvinyl | — | — | — | — | — | — | — | — | — | — | — | — | 2 | — | — | — | — | — | — |
| | | alcohol | | | | | | | | | | | | | | | | | | | |
| | Solvent | 1,2- | 2 | 2 | 2 | 2 | 2 | 2 | 2 | 2 | 2 | 2 | 2 | 2 | 2 | 2 | 2 | 2 | 2 | 2 | 2 |
| | | Hexane- | | | | | | | | | | | | | | | | | | | |
| | | diol | | | | | | | | | | | | | | | | | | | |
| | | Glycerin | 5 | 5 | 5 | 5 | 5 | 5 | 5 | 5 | 5 | 5 | 5 | 5 | 5 | 5 | 5 | 5 | 5 | 5 | 5 |
| | | 2- | 2 | 2 | 2 | 2 | 2 | 2 | 2 | 2 | 2 | 2 | 2 | 2 | 2 | 2 | 2 | 2 | 2 | 2 | 2 |
| | | Pyrroli- | | | | | | | | | | | | | | | | | | | |
| | | done | | | | | | | | | | | | | | | | | | | |
| | | Propylene | 2 | 2 | 2 | 2 | 2 | 2 | 2 | 58 | 2 | 2 | 2 | 2 | 2 | 2 | 2 | 2 | 2 | 2 | 60 |
| | | glycol | | | | | | | | | | | | | | | | | | | |
| | | Water | 58 | 58 | 58 | 53 | 53 | 43 | — | — | 56 | 61 | 74 | 74 | 74 | 74 | 66 | 58 | 58 | 58 | — |
| | | Ethanol | — | — | — | — | — | — | 56 | — | — | — | — | — | — | — | — | — | — | — | — |
| | Poly- | “CARRY- | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| | carbo- | BON | | | | | | | | | | | | | | | | | | | |
| | xylic | L400” | | | | | | | | | | | | | | | | | | | |
| | acid | (which is | | | | | | | | | | | | | | | | | | | |
| | | a product | | | | | | | | | | | | | | | | | | | |
| | | of Sanyo | | | | | | | | | | | | | | | | | | | |
| | | Chemical | | | | | | | | | | | | | | | | | | | |
| | | Industries, | | | | | | | | | | | | | | | | | | | |
| | | Ltd.) | | | | | | | | | | | | | | | | | | | |
| | Sur- | OLFINE | 1 | 1 | 1 | 1 | 1 | 1 | 1 | 1 | 1 | 1 | 1 | 1 | 1 | 1 | 1 | 1 | 1 | 1 | 1 |
| | factant | (trade | | | | | | | | | | | | | | | | | | | |
| | | name) | | | | | | | | | | | | | | | | | | | |
| | | E1010 | | | | | | | | | | | | | | | | | | | |

| | | | | | | | | | | | | | | | | | | | |
|---|---|---|---|---|---|---|---|---|---|---|---|---|---|---|---|---|---|---|---|
| Content of titanium | 10 | 10 | 10 | 15 | 15 | 15 | 2 | 2 | 2 | 10 | 10 | 10 | 10 | 10 | 10 | 10 | 10 | 10 | 10 |
| oxide (% by mass) | | | | | | | | | | | | | | | | | | | |
| Content of silicon | 10 | 10 | 10 | 10 | 10 | 15 | 15 | 15 | 15 | 15 | 2 | 2 | 2 | 2 | 2 | 2 | 10 | 10 | 10 |
| oxide (% by mass) | | | | | | | | | | | | | | | | | | | |
| Content of resin (% | 10 | 10 | 10 | 10 | 10 | 15 | 15 | 15 | 15 | 2 | 2 | 2 | 2 | 2 | 10 | 10 | 10 | 10 | 10 |
| by mass) | | | | | | | | | | | | | | | | | | | |
| Average particle | 0.2 | 0.2 | 0.2 | 4 | 2 | 0.03 | 0.67 | 0.4 | 0.6 | 6.7 | 0.06 | 0.1 | 0.2 | 0.2 | 0.33 | 10 | 13.3 | 9 | 0.67 |
| diameter of silicon | | | | | | | | | | | | | | | | | | | |
| oxide/Average | | | | | | | | | | | | | | | | | | | |
| particle diameter of | | | | | | | | | | | | | | | | | | | |
| titanium oxide | | | | | | | | | | | | | | | | | | | |

TABLE 6

| | | Exam- | Exam- | Exam- | Exam- | Exam- | Exam- | Exam- | Exam- | Exam- | Exam- | Exam- |
|---|---|---|---|---|---|---|---|---|---|---|---|---|
| | | ple | ple | ple | ple | ple | ple | ple | ple | ple | ple | ple |
| | | 41 | 42 | 43 | 44 | 45 | 46 | 47 | 48 | 49 | 50 | 51 |
| Evalu- | Stability | A | A | A | A | A | B | A | A | B | B | A |
| ation | to | | | | | | | | | | | |
| Re- | precipitation | | | | | | | | | | | |
| sults | on | | | | | | | | | | | |
| | (Supernatant | | | | | | | | | | | |
| | part) | | | | | | | | | | | |
| | Supernatant | 0.5 | 0.5 | 0.5 | 0.5 | 0.5 | 0.5 | 0.5 | 0.5 | 0.5 | 0.5 | 0.5 |
| | part | mm | mm | mm | mm | mm | mm | mm | mm | mm | mm | mm |
| | (Bottom) | or | or | or | or | or | or | or | or | or | or | or |
| | | less | less | less | less | less | less | less | less | less | less | less |
| | Whiteness | B | A | A | B | B | C | B | B | A | B | A |
| | Water | A | A | A | A | A | A | A | A | A | A | A |
| | | | | | | | Com- | Com- | Com- | Com- | Com- | Com- |
| | | | | | | | par- | par- | par- | par- | par- | par- |
| | | | | | | | ative | ative | ative | ative | ative | ative |
| | | | | | Exam- | Exam- | Exam- | Exam- | Exam- | Exam- | Exam- | Exam- |
| | | | | | ple | ple | ple | ple | ple | ple | ple | ple |
| | | | | | 52 | 53 | 41 | 42 | 43 | 44 | 45 | 46 |

| | | | | | | | | | |
|---|---|---|---|---|---|---|---|---|---|
| Evalu- | Stability | B | B | C | C | B | C | C | B |
| ation | to | | | | | | | | |
| Re- | precipitation | | | | | | | | |
| sults | on | | | | | | | | |
| | (Supernatant | | | | | | | | |
| | part) | | | | | | | | |
| | Supernatant | 0.5 | 0.5 | 1 mm | 2 mm | 0.5 | 2 mm | 2 mm | 0.5 |
| | part | mm | mm | | | mm | | | mm |
| | (Bottom) | or | or | | | or | | | or |
| | | less | less | | | less | | | less |
| | Whiteness | A | A | A | A | D | B | B | D |
| | Water | A | B | A | A | A | A | A | A |

In the white pigment composition of each of Examples 41 to 53, which was obtained by combining the titanium oxide particles having an average particle diameter in a predetermined range, the silicon oxide particles having an average particle diameter in a predetermined range, and the resin, the stability to precipitation (the supernatant part) was evaluated as A or B. In addition, in each of these white pigment inks, the whiteness during drying was evaluated as A or B. From the above, it was confirmed that each of the white pigment inks can improve the non-precipitating property and the whiteness in good balance. On the other hand, it was confirmed that when the average particle diameter of the titanium oxide particles was too large as in Comparative Example 41 or 42, the non-precipitating property was not sufficient and when the average particle diameter of the titanium oxide particles was too small as in Comparative Example 43, the whiteness was not sufficient. In addition, it was confirmed that when the average particle diameter of the silicon oxide particles was too large as in Comparative Examples 44 and 45, the non-precipitating property was not sufficient.

The entire disclosure of Japanese Patent Application No.: 2017-249491, filed Dec. 26, 2017 and 2017-249496, filed Dec. 26, 2017 and 2017-249499, filed Dec. 26, 2017 are expressly incorporated by reference herein.

What is claimed is:

1. A white pigment composition comprising:
core shell titanium oxide particles that each have a core particle and a shell layer covering a surface of the core particle and formed of titanium oxide, and have an average particle diameter of 50 nm or more and 5000 nm or less;
silicon oxide particles that have an average particle diameter of 3 nm or more and 100 nm or less; and
a resin.

2. The white pigment composition according to claim 1,
wherein, when a coating medium is coated with the white pigment composition to form predetermined coated matter, Expression (1) is satisfied.
L₁*/L₂*≥1.10 (1)
L₁*: Brightness (L* value) after drying the coated matter at 160° C.
L₂*: Brightness (L* value) after drying the coated matter at a room temperature

3. The white pigment composition according to claim 1,
wherein, when the white pigment composition is put into a container having a columnar internal shape and is centrifuged at a centrifugal force of 100 G for 10 hours, there is no sediment in which a ratio of a thickness to a height of the entire white pigment composition is 0.025 or more.

4. The white pigment composition according to claim 1,
wherein a ratio Dₐ/D_{b} between an average particle diameter Dₐ of the silicon oxide particles and an average particle diameter D_{b} of the core shell titanium oxide particles is less than 1.

5. The white pigment composition according to claim 1,
wherein a content of the core shell titanium oxide particles to the entire white pigment composition is 2% by mass or more and 15% by mass or less,
a content of the silicon oxide particles to the entire white pigment composition is 2% by mass or more and 15% by mass or less, and
a content of the resin to the entire white pigment composition is 2% by mass or more and 15% by mass or less.

6. The white pigment composition according to claim 1, which is for a white paint.

7. The white pigment composition according to claim 1, which is for a white ink.

8. An ink jet recording method comprising:
discharging the white pigment composition according to claim 7 to a recording medium by an ink jet method to coat the recording medium; and
drying the white pigment composition with which the recording medium is coated.

9. A white pigment composition comprising:
titanium oxide particles having an average particle diameter of 15 nm or more and 100 nm or less;
silicon oxide particles having an average particle diameter of 3 nm or more and 100 nm or less; and
a resin,
wherein, when a coating medium is coated with the white pigment composition to form predetermined coated matter, Expression (2) is satisfied.
L₁*/L₂*≥1.10 (2)
L₁*: Brightness (L* value) after drying the coated matter at 160° C.
L₂*: Brightness (L* value) after drying the coated matter at a room temperature

10. The white pigment composition according to claim 9,
wherein a ratio Dₐ/D_{b} between an average particle diameter Dₐ of the silicon oxide particles and an average particle diameter D_{b} of the titanium oxide particles is less than 1.

11. The white pigment composition according to claim 9,
wherein a content of the titanium oxide particles to the entire white pigment composition is 2% by mass or more and 15% by mass or less,
a content of the silicon oxide particles to the entire white pigment composition is 2% by mass or more and 15% by mass or less, and
a content of the resin to the entire white pigment composition is 2% by mass or more and 15% by mass or less.

12. The white pigment composition according to claim 9, which is for a white paint.

13. The white pigment composition according to claim 9, which is for a white ink.

14. An ink jet recording method comprising:
discharging the white pigment composition according to claim 13 to a recording medium by an ink jet method to coat the recording medium; and
drying the white pigment composition with which the recording medium is coated.

15. A white pigment composition comprising:
titanium oxide particles having an average particle diameter of 15 nm or more and 100 nm or less;
silicon oxide particles having an average particle diameter of 3 nm or more and 100 nm or less; and
a resin,
wherein, when the white pigment composition is put into a container having a columnar internal shape and is centrifuged at a centrifugal force of 100 G for 10 hours, there is no sediment in which a ratio of a thickness to a height of the entire white pigment composition is 0.025 or more.

16. The white pigment composition according to claim 15,
wherein a ratio Dₐ/D_{b} between an average particle diameter Dₐ of the silicon oxide particles and an average particle diameter D_{b} of the titanium oxide particles is less than 1.

17. The white pigment composition according to claim 15,
wherein a content of the titanium oxide particles to the entire white pigment composition is 2% by mass or more and 15% by mass or less,
a content of the silicon oxide particles to the entire white pigment composition is 2% by mass or more and 15% by mass or less, and
a content of the resin to the entire white pigment composition is 2% by mass or more and 15% by mass or less.

18. The white pigment composition according to claim 15, which is for a white paint.

19. The white pigment composition according to claim 15, which is for a white ink.

20. An ink jet recording method comprising:
discharging the white pigment composition according to claim 19 to a recording medium by an ink jet method to coat the recording medium; and
drying the white pigment composition with which the recording medium is coated.
